(19) United States
(12) Patent Application Publication
(10) Pub. No.: US 2007/0048180 A1
(43) Pub. Date: Mar. 1, 2007

(54) Nanoelectronic breath analyzer and asthma monitor

(76) Inventors: Jean-Christophe P. Gabriel, Pinole, CA (US); Vikram Joshi, Newington, CT (US); Joseph Niemann, Fremont, CA (US); Alexander Star, Pittsburgh, PA (US); David Thomas, San Francisco, CA (US); Christian Valcke, Orinda, CA (US)

Correspondence Address: O'MELVENY & MYERS LLP, 610 NEWPORT CENTER DRIVE, 17TH FLOOR, NEWPORT BEACH, CA, 92660, US

(21) Appl. No.: 11/437,275

(22) Filed: May 18, 2006

Related U.S. Application Data
(63) Continuation-in-part of application No. 10/656,898, filed on Sep. 5, 2003.
(63) Continuation-in-part of application No. 10/940,324, filed on Sep. 13, 2004.
(63) Continuation-in-part of application No. 11/019,792, filed on Dec. 20, 2004.
(63) Continuation-in-part of application No. 11/390,493, filed on Mar. 27, 2006.
(60) Provisional application No. 60/408,547, filed on Sep. 5, 2002.
(60) Provisional application No. 60/502,485, filed on Sep. 12, 2003.
(60) Provisional application No. 60/531,079, filed on Dec. 18, 2003.
(60) Provisional application No. 60/665,153, filed on Mar. 25, 2005.
(60) Provisional application No. 60/683,460, filed on May 19, 2005.
(60) Provisional application No. 60/730,905, filed on Oct. 27, 2005.
(60) Provisional application No. 60/773,138, filed on Feb. 13, 2006.

(51) Int. Cl. G01N 31/22

(52) U.S. Cl. 422/57

(57) ABSTRACT

Nanoelectronic sensors, including sensors for detecting analytes such as CO₂, NO, anesthesia gases, and the like in human breath. An integrated multivalent monitor system is described which permits two or more analytes to be measured in breath, for example to monitor pulmonary conditions such as asthma. The monitor system may be configured to be compact, light weight, inexpensive, and to include a microprocessor capable of both analyzing measurements to determine patient status, and storing measurement history. Wireless embodiments provide such enhancements as remote monitoring.

### CROSS-REFERENCE TO RELATED APPLICATIONS

This application is a continuation-in-part of co-pending U.S. patent application Ser. No. 10/656,898 filed Sep. 5, 2003 entitled “Polymer Recognition Layers For Nanostructure Sensor Devices” (published as US 2005-0279,987), which in turn claims priority to Provisional Application No. 60/408,547 filed Sep. 5, 2002, which applications are incorporated by reference.

This application is a continuation-in-part of and claims priority to U.S. patent application Ser. No. 10/940,324 filed Sep. 13, 2004 entitled “Carbon Dioxide Nanoelectronic Sensor” (published as US 2005-0129,573), which in turn claims priority to U.S. Provisional Patent Application No. 60/502,485 filed Sep. 12, 2003, which applications are incorporated by reference.

This application is a continuation-in-part of and claims priority to U.S. patent application Ser. No. 11/019,792 filed Dec. 18, 2004 entitled “Nanoelectronic capnometer adapter” (published as US 2005-0245,836); which in turn claims priority to U.S. Provisional Patent Application No. 60/531,079, filed Dec. 18, 2003, which applications are incorporated by reference.

This application is a continuation-in-part of and claims priority to U.S. patent application Ser. No. 11/390,493, filed Mar. 27, 2006 entitled “Nanoelectronic Measurement System For Physiologic Gases, And Improved Nanosensor For Carbon Dioxide”; which in turn claims priority to U.S. Provisional Patent Application No. 60/665,153 filed Mar. 25, 2005, which applications are incorporated by reference.

This application claims priority to the following U.S. Provisional Applications: No. 60/683,460, filed May 19, 2005, entitled “Multi-Valent Breath Analyzer having nanoelectronic sensors, and it use in Asthma monitoring”, No. 60/730,905 filed Oct. 27, 2005, entitled “Nanoelectronic Sensors And Analyzer System For Monitoring Anesthesia Agents And Carbon Dioxide In Breath”; and U.S. Provisional Application No. 60/773,138, filed Feb. 13, 2006 entitled “Nanoelectronic Capacitance Sensors For Monitoring Analytes”, which applications are each incorporated by reference.

### BACKGROUND

1. Field of the Invention

The present invention relates to nanostructured sensor systems for measurement analytes, for example by measurement of variations of capacitance, impedance or other electrical properties of nanostructure elements in response to an analyte, and in particular to nanostructured sensor systems for measurement of medically relevant species in breath.

2. Description of Related Art

The measurement of carbon dioxide levels in respiration is a standard procedure during intensive care and anesthesia and is a primary tool in the diagnosis and management of respiratory function. A need in this medical monitoring is to measure and track carbon dioxide (CO₂) concentration in the breath, sometimes referred to as capnography. To meet the requirements of capnography devices, prevailing technology relies on bulky and expensive non-dispersive infrared absorption (NDIR) sensors to determine CO₂ concentration. The high cost, complexity, weight and other limitations restrict the use of capnography to high value, controlled environments, such as surgical wards, and limits the medical use of capnography.

In addition to the measurement of CO₂, medical breath analysis and monitoring may employ measurements of many other chemical species to improve diagnosis and patient care. In general, exhaled breath has a composition which is distinct from inspired air. Compounds are either removed from inspired air (e.g., oxygen as O₂ is absorbed and metabolized) or added to exhaled breath (e.g., CO₂, H₂O). In addition, treatment compounds (e.g., anesthetic agents) may be added to inspired air for inhaled administration, and may be detected in exhaled breath.

Although the substantial portions of exhaled breath include N₂, O₂, CO₂, water vapor and other atmospheric constituents (e.g., argon and the like), many volatile organic and inorganic chemical species which are produced by metabolic processes within the body are released in exhaled breath (often in only trace amounts). Such metabolic species often have medical significance. For example, nitric oxide (NO), nitrogen dioxide (NO₂), other nitrogen-containing compounds, sulfur-containing compounds, hydrogen peroxide, carbon monoxide, hydrogen, ammonia, ketones, aldehydes, esters, alkanes, and other volatile organic compounds may be present in exhaled breath. Medical conditions related to such metabolic exhaled breath constituents include tissue inflammation (e.g. asthma), immune responses (e.g. to cancer cells or bacteria), metabolic problems (e.g. diabetes), digestive processes, liver problems, kidney problems, heart problems, gum disease, halitosis, blood component levels, and other physiological conditions.

NO detection in breath is a proven marker for airway inflammation (as well as for other tissue inflammation, immune responses, and other conditions). Therefore, the ability to measure NO as an exhaled breath parameter, for example as fractional exhaled nitric oxide (FeNO), is a valuable tool for diagnosis, monitoring, and managed treatment of asthma and other disorders. See, for example, U.S. Pat. No. 6,010,459 entitled “Method and apparatus for the measurement of components of exhaled breath in humans”, which is incorporated by reference. However, medical systems for the measurement of NO suffer from generally the same limitations as capnograph devices, e.g., high cost, weight and complexity.

CO₂ detection in breath has been used as an indicator of perfusion and heart function as well as ventilator effectiveness. In addition, CO₂ is useful, by itself or in combination with other measurements, in diagnosing and monitoring airway status and pulmonary function. For example, see U.S. Pat. No. 6,648,833 entitled “Respiratory analysis with capnography”, which is incorporated by reference.

### SUMMARY

Embodiments having aspects of the invention provide capnography devices which bring the advantages of novel nanostructured electronic sensors to medical applications: (i) performance that matches or exceeds that of infrared technology; (ii) plug-and-play simplicity in a disposable package; (iii) the small size and low power consumption needed for portability and/or wireless integration; (iv) the ability to incorporate arrays of sensors on a single chip; and (v) an order of magnitude reduction in the cost of the sensor component. See, for example, U.S. patent application Ser. No. 11/019,792 filed Dec. 18, 2004 entitled “Nanoelectronic Capnometer Adapter” (published as US 2005/0245,836), which is incorporated by reference.

It has also been proposed to monitor medical conditions, such as asthma, using detection of more than one metabolic species, for example considering both NO and CO₂ in exhaled breath. For example, see US Published Application No. 2003/0134,427 entitled “Method and apparatus for determining gas concentration ”; and C. Roller et al., “Simultaneous NO and CO₂ measurement in human breath with a single IV-VI mid-infrared laser”, Optics Letters (2002) Vol. 27, No. 2, pgs. 107-109; each of which is incorporated by reference.

There are several different conventional technologies for sensing NO gas for medical breath analysis applications. In laser detection, a laser may be tuned to a frequency which is selectively absorbed by NO. A photo detector then detects the transmission of laser light through a sample column, the degree of absorption by the gas being related to NO concentration. See for example, the experimental Breathmeter™ breath analyser, being developed by Ekips Technologies, Inc. of Norman OK. NO may also be detected by such methods as chemiluminescence, electrochemical reactions, and other optical detection methods. See, for example, U.S. Pat. No. 6,038,913 entitled “Device for determining the levels of NO in exhaled air”; US Published Application No. 2003/0134,427, entitled “Method and apparatus for determining gas concentration”, and US Published Application No. 2004/0017,570 entitled “Device and system for the quantification of breath gases”, each of which is incorporated by reference.

However, each of the conventional NO detection strategies suffer limitations in equipment size, weight, cost and/or operational complexity that limit their use for a low-cost, patent-portable. As with capnography, device embodiments having aspects of the invention herein and including novel nanostructured electronic sensors provide the advantages small size, low weight and cost, and simple operation that make them particularly suitable to such patient care alternatives.

Alternative embodiments having aspects of the invention include systems configured to measure more than one exhaled breath constituent, so as to provide monitoring and diagnosis based on patient-specific characteristics related to two or more of NO, CO₂, H₂O₂ and other compounds. Likewise, the characteristics of the novel nanoelectronic sensors lend them to employment embodiments including sensor arrays, microprocessors and/or wireless transceivers, permitting convenient recordation and analysis of multivalent patient-specific measurement histories and/or remote patient monitoring by treatment personnel. See, for example, U.S. patent application Ser. No. 11/111,121 filed Apr. 20, 2005 entitled “Remotely communicating, battery-powered nanostructure sensor devices”; each of which is incorporated by reference.

Nanotubes were first reported in 1993 by S. Iijima and have been the subject of intense research since. Single walled nanotubes (SWNTs) are characterized by strong covalent bonding, a unique one-dimensional structure, and exceptionally high tensile strength, high resilience, metallic to semiconducting electronic properties, high current carrying capacity, and extreme sensitivity to perturbations caused by charged species in proximity to the nanotube surface.

Exemplary embodiments of sensor devices having aspects of the invention provide for detection of chemical, physiologic, or biomolecular species employing nanostructures as elements, both for use in gaseous and in liquid media, such as biological fluids, electrolytes, and the like. Real time electronic detection and monitoring and offers high sensitivity, is rapid and reversible, and has a large dynamic range. The output is digital so electronic filtering and post processing may be used to eliminate extraneous noise, if need be. Certain embodiments include multiplexed assays on a single sensor platform or chip.

Alternative embodiments having aspects of the invention are configured for detection of analytes employing nanostructured sensor elements configured as one or more alternative types of electronic devices, such as capacitive sensors, resistive sensors, impedance sensors, field effect transistor sensors, and the like, or combinations thereof. Two or more such measurement strategies in a may be included in a sensor device so as to provide orthogonal measurements that increase accuracy and/or sensitivity. Embodiments may have functionalization groups or material associated with nanostructured elements to provide sensitive, selective analyte response.

Although in the description herein a number of exemplary sensor embodiments are based on one or more carbon nanotubes, it is understood that other nanostructures known in the art may also be employed, e.g., semiconductor nanowires, various form of fullerenes, multiwall nanotubes, and the like, or combinations thereof. Elements based on nanostructures such carbon nanotubes (CNT) have been described for their unique electrical characteristics. Moreover, their sensitivity to environmental changes (charged molecules) can modulate the surface energies of the CNT and be used as a detector. The modulation of the CNT characteristic can be investigated electrically by building devices that incorporate the CNT (or CNT network) as an element of the device. This can be done as a gate transistor element or as a capacitive effect.

Certain exemplary embodiments having aspects of the invention include single-walled carbon nanotubes (SWNTs) as semiconducting or conducting elements. Such elements may comprise single or pluralities of discrete parallel NTs, e.g., in contact or electrically communicating with a device electrode. For many applications, however, it is advantageous to employ semiconducting or conducting elements comprising a generally planar network region of nanotubes (or other nanostructures) substantially randomly distributed adjacent a substrate, conductivity being maintained by interconnections between nanotubes.

Devices fabricated from random networks of SWNTs eliminates the problems of nanotube alignment and assembly, and conductivity variations, while maintaining the sensitivity of individual nanotubes For example, such devices are suitable for large-quantity fabrication on currently on 4-inch silicon wafers, each containing more than 20,000 active devices. These devices can be decorated with specific recognition layers to act as a transducer for the presence of the target analyte. Such networks may be made using chemical vapor deposition (CVD) and traditional lithography, by solvent suspension deposition, vacuum deposition, and the like. See for example, U.S. patent application Ser. No. 10/177,929 entitled “Dispersed Growth of Nanotubes on a Substrate”; U.S. Pat. No. 6,894,359 entitled “Sensitivity Controlfor Nanotube Sensors”; U.S. patent application Ser. No. 10/846,072 entitled “Flexible Nanotube Transistors”; and L. Hu et al., Percolation in Transparent and Conducting Carbon Nanotube Networks, Nano Letters (2004), 4, 12, 2513-17, each of which application and publication is incorporated herein by reference.

The nanoscale elements can be fabricated into arrays of devices on a single chip for multiplex and multiparametric applications See for example, U.S. patent application Ser. No. 10/388,701 entitled “Modification of Selectivity for Sensing for Nanostructure Device Arrays”; U.S. patent application Ser. No. 10/656,898 entitled “Polymer Recognition Layers for Nanostructure Sensor Devices”, U.S. patent application Ser. No. 10/940,324 entitled “Carbon Dioxide Nanoelectronic Sensor”; and U.S. Provisional Patent Application No. 60/564,248 entitled “Remotely Communicating, Battery-Powered Nanostructure Sensor Devices”; each of which is incorporated herein by reference.

Certain embodiments having aspects of the invention include a breath analyzer or medical monitor comprising:
at least a first nanoelectronic sensors, the sensor including a substrate; one or more nanostructures disposed over the substrate; one or more conducting elements in electrical communication with the nanostructure; and at least one recognition material operatively associated with the first nanostructure, the at least one recognition material configured to provide a sensitivity to a first analyte found in human breath;
a breath sampler configured to sample at least the exhaled breath of a patient, and in communication with the sensor; and
processing unit configured to receive a signal from the first sensor and to use the signal to measure the concentration of the first analyte, so as to provide information related to a medical state of the patient.

Certain breath analyzer embodiments may further comprise at least a second nanoelectronic sensor, which may be configured generally similar to the first sensor, and which includes recognition material configured to provide a sensitivity to a second analyte found in human breath; and wherein the processing unit is configured to receive a signal from the second sensor to use the signal to measure the concentration of the second analyte, so as to provide information related to a medical state of the patient. Certain breath analyzer embodiments may further comprise a output device to provide information related to the a medical state of the patient to a user.

The breath analyzer processing unit may be configured to compare the measurement of the first analyte with the measurement of the second analyte, so as to determine a relationship between the measurements indicative of a medical state of the patient. The analytes may include, for example, carbon dioxide (CO₂),the second analyte may include nitric oxide (NO), and the processing unit may be configured to determine a relationship of the measured concentrations of CO₂ and NO in the sampled breath so as to provide an assessment of human airway inflammation of the patient.

In certain examples, the processing unit may be configured to determine an asthma status, and the output device to provide information related to the asthma status to a user. The breath analyzer may be substantially portable by a patient or other user, and configured to provide information related to the an asthma status to the patient or caretaker on a substantially real-time basis.

In certain embodiments, the one or more nanostructures comprise a network of carbon nanotubes, e.g., wherein at least a portion of the network is in contact with the one or more conducting elements. The conducting elements may include a source and a drain electrode separated from one another by a source-drain gap. In certain examples, the network of carbon nanotubes comprises nanotubes having a characteristic length substantially less than the source-drain gap, so that the nanotubes comprising the network substantially contact at most only one of the source and drain electrodes. In other examples, the characteristic length is substantially greater than the source-drain gap, so that a substantial portion of the nanotubes comprising the network contact both the source and the drain electrodes. The breath analyzer sensors may further comprise a gate electrode; and the sensor signal may be indicative of a property of the nanostructure under the influence of a gate voltage. Alternatively, the sensor signal may be indicative of a capacitance property of the nanostructure. In certain embodiments, a breath analyzer or monitor having aspects of the invention may be configured to measure one or more analytes selected from the group consisting essentially of CO₂, NO, NO₂, and H₂O₂. The breath sampler may be configured to delivery a continuing breath sample to either or both of the first sensor and the second sensor during at least a substantial portion of a patient exhalation; and the processing unit may be configured to determine a history of the concentration of either or both of the first analyte and the second analyte during the exhalation. The breath sampler may be configured to control pressure of the breath sample during the course of a patient exhalation.

### BRIEF DESCRIPTION OF THE DRAWINGS

The following is a list and summary of the figures herein:

FIG. 1A is a cross-sectional diagram which illustrates an exemplary electronic sensing device for detecting an analyte, configured in this example as a NTFET.

FIG. 1B is a photograph of a sensor generally similar to that of FIG. 1, fabricated on a chip and mounted on a circuit board.

FIG. 2 shows is a plot or the response of an exemplary nanoelectronic carbon dioxide sensor having aspects of the invention to a wide range of concentrations of carbon dioxide.

FIG. 3 is a plot of the response of an exemplary nanoelectronic carbon dioxide sensor having aspects of the invention to low concentrations of carbon dioxide.

FIG. 4 is a capnogram plot showing the response of an exemplary capnometer having aspects of the invention to simulated human breathing.

FIG. 5 shows a plot of the response of an exemplary nanostructure sensor, having aspects of the invention to a short exposure to NO in air.

FIG. 6 shows a plot demonstrating that the NO sensor device of FIG. 5 has little or no cross-sensitivity when exposed to a CO₂ concentration representative of breath.

FIG. 7 shows a schematic of an exemplary capacitive sensor having aspects of the invention,

FIG. 8 shows a plot of the response of an exemplary nanostructure sensor, such as is shown in FIG. 7 during brief exposure to isoflurane, and to halothane.

FIG. 9 illustrates a portable multi-valent breath analyzer having aspects of the invention.

FIGS. 10A-10C are reproduced from U.S. Pat. No. 6,648,833 for additional illustration of capnogram characteristics, wherein:. FIG. 10A shows a representative capnogram and a corresponding schematic diagram of an alveolus of a healthy patient; FIG. 10B shows a representative capnogram and a corresponding schematic diagram of an alveolus of a patient having obstructive lung disease; and FIG. 10C. shows a representative capnogram and a corresponding schematic diagram of an alveolus of a patient having restrictive lung disease.

FIG. 11. shows a plot showing the dependence of NO in exhaled breath on exhalation rate, reproduced from U.S. Pat. No. 6,733,463.

FIG. 12. shows a representative plot of the profile of fractional composition of NO in a patients exhaled breath.

FIGS. 13A to 13G. schematic illustrations showing a number of alternative sensor mounting arrangements that may be employed in breath sampler included in FIG. 9.

### FURTHER DESCRIPTION OF EMBODIMENTS

### 1. Nanosensor Architecture

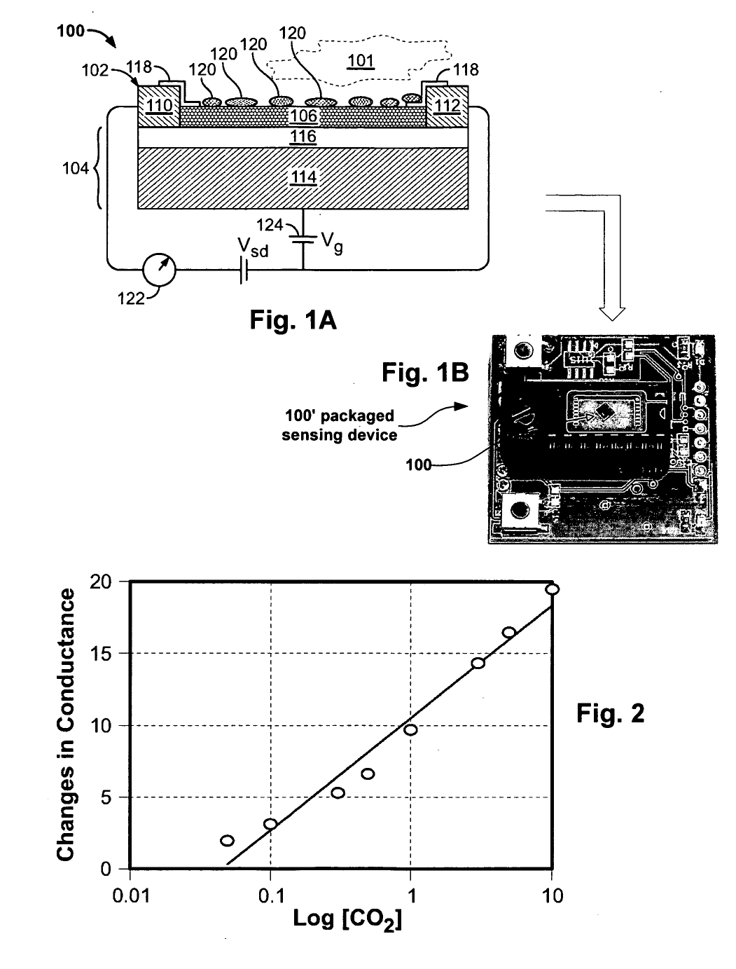

FIG. 1 shows an exemplary electronic sensing device 100 having aspects of the invention, for detecting an analyte 101 (e.g. CO₂, H₂ or NO, and the like), comprising a nanostructure sensor 102. Sensor 102 comprises a substrate 104, and a conducting channel or layer 106 comprising a nanostructure material, such as a nanotube or network of nanotubes, disposed on the substrate. The nanostructure material 106 may contact the substrate as shown, or in the alternative, may be spaced a distance away from the substrate, with or without a layer of intervening material.

In an embodiment of the invention, conducting channel 106 may comprise one or more carbon nanotubes. For example, conducting channel 106 may comprise a plurality of nanotubes forming a mesh, film or network. Certain exemplary embodiments having aspects of the invention include nanostructure elements which may be made using chemical vapor deposition (CVD) and traditional lithography, or may be deposited by other methods, such as solvent suspension deposition, AFM manipulation, and the like. Certain embodiments include one or more discrete nanotubes in electrical contact with one or more metal electrodes. A number of different arrangements of active nanostructures may be included without departing from the spirit of the invention.

At least two conductive elements or contacts 110, 112 may be disposed over the substrate and electrically connected to conducting channel 106 comprising a nanostructure material. Elements 110, 112 may comprise metal electrodes in contact with conducting channel 106. In the alternative, a conductive or semi-conducting material (not shown) may be interposed between contacts 110, 112 and conducting channel 106. Contacts 110, 112 may comprise source and drain electrodes, respectively, upon application of a source-drain voltage V_{sd}. The voltage or polarity of source 110 relative to drain 112 may be variable, e.g., the applied voltage may be DC, AC, pulsed, or variable. In an embodiment of the invention, the applied voltage is a DC voltage.

In the example of FIG. 1, the device 100 may be operated as a gate-controlled field effect transistor, with sensor 102 further comprising a gate electrode 114. Such a device is referred to herein as a nanotube field effect transistor or NTFET. Gate 114 may comprise a base portion of substrate 104, such as a doped-silicon wafer material isolated from contacts 110, 112 and channel 106 by a dielectric layer 116, so as to permit a capacitance to be created by an applied gate voltage V_{g}. For example, the substrate 104 may comprise a silicon back gate 114, isolated by a dielectric layer 116 comprising SiO₂.

Sensor 102 may further comprise a layer of inhibiting or passivation material 118 covering regions adjacent to the connections between the conductive elements 110, 112 and conducting channel 106. The inhibiting material may be impermeable to at least one chemical species, such as to the analyte 101 or to environmental materials such as water or other solvents, oxygen, nitrogen, and the like. The inhibiting material 118 may comprise a passivation material as known in the art, such as silicon dioxide, aluminum oxide, silicon nitride, or other suitable material. Further details concerning the use of inhibiting materials in a NTFET are described in prior U.S. Pat. No. 6,894,359 entitled “Sensitivity Control For Nanotube Sensors” which is incorporated by reference herein.

The conducting channel 106 (e.g., a carbon nanotube layer) may be functionalized to produce a sensitivity to one or more target analytes 101. Although nanostructures such as carbon nanotubes may respond to a target analyte through charge transfer or other interaction between the device and the analyte, more generally a specific sensitivity can be achieved by employing a recognition material 120, also called a functionalization material, that induces a measurable change in the device characteristics upon interaction with a target analyte.

Device 100 may further comprise suitable circuitry in communication with sensor elements to perform electrical measurements. For example, a conventional power source may supply a source drain voltage V_{sd} between contacts 110, 112. Measurements via the sensor device 100 may be carried out by circuitry represented schematically by meter 122 connected between contacts 110, 112. In embodiments including a gate electrode 114, a conventional power source 124 may be connected to provide a selected or controllable gate voltage V_{g}. Device 100 may include one or more electrical supplies and/or a signal control and processing unit (not shown) as known in the art, in communication with the sensor 102.

Optionally, device 100 may comprise a plurality of sensors like sensor 102 disposed in a pattern or array, such as described in prior application Ser. No. 10/388,701 filed Mar. 14, 2003 entitled “Modification Of Selectivity For Sensing For Nanostructure Device Arrays” (now published as US 2003-0175161), which is incorporated by reference herein. Each device in the array may be functionalized with identical or different functionalization. Identical device in an array can be useful in order to multiplex the measurement to improve the signal/noise ratio or increase the robustness of the device by making redundancy. Different functionalization may be useful for providing sensitivity to a greater variety of analytes with a single device.

### 2. Particular Sensor Elements

Substrate. The substrate 104 may be insulating, or on the alternative, may comprise a layered structure, having a base 114 and a separate dielectric layer 116 disposed to isolate the contacts 110, 112 and channel 106 from the substrate base 114. The substrate 104 may comprise a rigid or flexible material, which may be conducting, semiconducting or dielectric. Substrate 104 may comprise a monolithic structure, or a multilayer or other composite structure having constituents of different properties and compositions. Suitable substrate materials may include quartz, alumina, polycrystalline silicon, III-V semiconductor compounds, and other suitable materials. Substrate materials may be selected to have particular useful properties, such as transparency, microporosity, magnetic properties, monocrystalline properties, polycrystalline or amorphous properties, or various combinations of these and other desired properties. For example, in an embodiment of the invention, the substrate 104 may comprise a silicon wafer doped so as to function as a back gate electrode 114. The wafer being coated with intermediate diffusion barrier of Si₃N₄ and an upper dielectric layer of SiO₂. Optionally, additional electronic elements may be integrated into the substrate for various purposes, such as thermistors, heating elements, integrated circuit elements or other elements.

In certain alternative embodiments, the substrate may comprise a flexible insulating polymer, optionally having an underlying gate conductor (such as a flexible conductive polymer composition), as described in application Ser. No. 10/846,072 filed May 14, 2004 entitled “Flexible Nanotube Transistors”, the entirety of which application is incorporated herein by this reference. In further alternative embodiments, the substrate may comprise a microporous material permitting suction to be applied across the substrate, e.g., porous alumina for vacuum deposition of a nanotube network channel 106 from suspension or solution, as described in application Ser. No. 60/639954, filed Dec. 28, 2004, entitled “Nanotube Network-On-Top Architecture For Biosensor”, the entirety of which application is incorporated herein by reference.

Contacts or electrodes. The conductor or contacts 110, 112 used for the source and drain electrodes can be any of the conventional metals used in semiconductor industry, or may be selected from Au, Pd, Pt, Cr, Ni, ITO, W or other metallic material or alloy or mixture thereof. In the alternative, the contact may comprise a multi-layer or composite of metallic materials, such as Ti+Au, Cr+Au, Ti+Pd, Cr+Pd, or the like. A multi-layer construction may help in improving the adhesion of the metal to the substrate. For example, electrical leads may be patterned on top of a nanotube network channel from titanium films 30 nm thick capped with a gold layer 120 nm thick. In the alternative, other conductive materials may be employed, such as conductive polymers and the like. The dimension of the distance between source 110 and drain 112 may be selected to achieve desired characteristics for a particular application. It should be understood that one or more of each of a source and drain electrode may be arranged in an interdigitated or spaced-apart electrode array, permitting a comparative large area of nanostructure channel 106 having a comparatively small source-drain gap to be arranged compactly.

Gate electrode 114 may comprise materials generally similar to contacts 110, 112. In the alternative, the gate electrode 114 may comprise a sublayer within substrate 104. Gate electrode 114 may comprise doped silicon, patterned metal, ITO, other conductive metal or non-metal material, or combinations thereof. Alternative forms of gate electrodes may be employed, such as a top gate, a gate effected via a conducting analyte carrier medium (e.g. an aqueous solution). Optionally, a device 102 may comprise such other electrodes as a counter electrode, a reference electrode, a pseudo-reference electrode, without departing from the spirit of the invention.

Conducting Channel Or Nanostructure Layer. Exemplary embodiments having aspects of the invention include sensor devices having at least one conducting channel 106 comprising one or more nanostructures. For example, conducting channel or layer 106 may comprise one or more single-wall carbon nanotubes, multiple-wall carbon nanotubes, nanowires, nanofibers, nanorods, nanospheres, or other suitable nanostructures. In addition, or in the alternative, conducting channel or layer 106 may comprise one or more nanostructures comprised of boron, boron nitride, and carbon boron nitride, silicon, germanium, gallium nitride, zinc oxide, indium phosphide, molybdenum disulphide, silver, or other suitable materials. Various suitable methods for manufacturing nanotubes and other nanostructures are known in the art, and any suitable method may be used.

Nanostructure Network Conducting Channel. In an embodiment of the invention, conducting channel or nanostructure layer 106 comprises an interconnected network of smaller nanostructures disposed to form a percolation layer, mesh, or film which provides at least one electrical conduction path between a source electrode 110 and a drain electrode 112. In such a network of nanoparticles, it is not necessary that any single nanoparticle extends entirely between the source and drain contacts. In operation the conductivity of channel 106 between source electrode 110 and drain electrode 112 may be maintained by interconnections, contacts or communications between adjacent nanostructures. Such networks of nanoparticles, such as nanotubes and the like, may be configured to be defect-tolerant, in that disruption of any particular conductive path may be compensated by remaining paths within the network. In an embodiment of the invention, nanostructure conducting channel 106 comprises one or more single-walled or multi-walled carbon nanotubes. The nanotubes may be arranged as clumps or bundles, or as distinct separated fibers. A useful network of nanotubes may be provided, for example, by distributing a dispersion of nanotubes over a substrate so as to be approximately planar and randomly oriented. For example, conducting channel 106 may comprise a network including a plurality of dispersed single wall carbon nanotubes (SWCNT), in which the nanotubes are oriented substantially randomly, non-parallel and separated with respect to one another (i.e., not clumped) as an interconnecting mesh disposed generally parallel to the substrate.

Electrical characteristics of the channel 106 may be optimized to suit a particular functionalization chemistry or other constituent of the sensor which effects conductivity, or to suit a desired range of analyte concentration. In preferred embodiments, the density or thickness of a nanotube network may be varied to provide a desired degree of conductivity between the source and drain electrodes. In the alternative, or in addition, the proportion of metallic or semiconducting nanotubes in the network may be selected to achieve a desired conductivity in the network. One advantage of using a nanostructure network architecture for the conducting channel 106 is that these factors may be varied to produce a conducting network having a selected margin above (or below) the percolation limit, permitting convenient optimization of device characteristics. For example, a NT network channel may be formed to be slightly below the percolation limit for the uncoated network, and modified by deposition of a conducting recognition material, such as Pd, to result in a functionalized channel of desired conductivity. In another example, the conductivity of an initially dry network may be selected to allow for operation in association with anticipated additional conductivity of a fluid analyte medium, such as a physiologic buffer or solvent.

In addition, a conducting channel 106 comprising a generally random dispersion of individual nanoparticles advantageously permits a “statistical,” rather than a “localized” approach to nanostructure device fabrication, which may be more amenable to demanding mass production techniques. In the “statistical” approach, electrical contacts can be placed anywhere on the dispersion of individual nanostructures to form devices, without a specific correspondence between electrode position and any particular nanoparticle position. The random dispersion of nanoparticles ensures that any two or more electrodes placed thereon can form a complete electrical circuit with functioning nanostructures providing the connection. By distributing a large plurality of randomly oriented nanotubes in a dispersion over (or under) an electrode array, uniform electrical properties in the individual devices can be assured with higher yields and faster processing than is possible using the prior art approach of controlled placement or growth of individual nanotubes or other nanostructures.

Nanoparticle Network Formation. Nanostructure networks may be formed by various suitable methods. One suitable approach may comprise forming an interconnecting network of single-wall carbon nanotubes directly upon the substrate, such as by reacting vapors in the presence of a catalyst or growth promoter disposed upon the substrate. For example, single-walled nanotube networks can be grown on silicon or other substrates by chemical vapor deposition from iron-containing catalyst nanoparticles with methane/hydrogen gas mixture at about 900 degree C.

Advantageously, the use of highly dispersed catalyst or growth-promoter for nanostructures permits a network of nanotubes of controlled diameter and wall structure to be formed in a substantially random and unclumped orientation with respect to one another, distributed substantially evenly at a selected mean density over a selected portion of the substrate. The particle size distribution may be selected to promote the growth of particular nanotube characteristics, such as tube diameter, number of walls (single or multi-walled), conductivity, or other characteristics.

Other catalyst materials and gas mixtures can be used to grow nanotubes on substrates, and other electrode materials and nanostructure configurations and are disclosed in application Ser. No. 10/099,664, filed Mar. 15, 2002 entitled “Modification Of Selectivity For Sensing For Nanostructure Sensing Device Arrays”, and in International Application No. PCT/JUS03/19,808, filed Jun. 20, 2003, entitled “Dispersed Growth Of Nanotubes On A Substrate” and published as WO2004-040,671, both of which applications are incorporated by reference.

In an alternative, conducting layer 106 comprising an interconnecting network of nanostructures may be formed by deposition from a solution or suspension of nanostructures, such as a solution of dispersed carbon nanotubes. See for example, the methods described in U.S. patent application Ser. No. 10/846,072, filed May 14, 2004 entitled “Flexible Nanotube Transistors”, which is incorporated by reference. Such methods as spin coating, spray deposition, dip coating and ink-jet printing may be employed to deposit the solution or suspension of nanostructures.

Yet another suitable approach may comprise forming a nanotube network by suction deposition on a porous substrate or membrane, as described in U.S. Provisional Application No. 60/639954, filed Dec. 28, 2004, entitled “Nanotube Network-On-Top Architecture For Biosensor”, which is incorporated by reference. The network thus formed may be used as a conducting channel either attached to its deposition membrane, or after being separated from the deposition membrane using a method such as membrane dissolution or transfer bonding.

Carbon nanotubes are known to exhibit either metallic or semiconductor properties, depending on the particular graphitic lattice orientation. Various methods may be employed to select a desired composition of nanotubes for a nanostructure layer 106 of a nanosensor device 102. For example, a plurality of generally similar nanotube devices may be fabricated in a parallel mass production process, such as an array of device dies disposed on a silicon wafer. Each of the plurality of devices will exhibit an electrical characteristic with a statistically predictable range of characteristics, due to differing metallic or semiconductor composition of each devices conducting layer 106. The fabricated dies may be individually tested, such as by automated or semi-automated pin probe test rigs. Dies exhibiting a selected electrical behavior or range of behavior may be marked and selected for further processing and use, and any non-conforming dies may be culled, or otherwise processed for other uses. In the alternative, a network of nanostructures for conducting channel 106 may be constructed from preprocessed source nanotube material which includes a selected composition of metallic versus semiconductor properties (e.g., solely semiconductor nanotubes). Alternatively, the nanotube layer may be formed of an arbitrary mixture of nanotube composition, and the layer subsequently treated to selectively remove, oxidize, disconnect or deactivate all or a portion of the metallic nanotubes, e.g. by ohmic heating, so as to leave a conducting channel of selected properties (e.g., solely semiconductor nanotubes). The latter approach may be used advantageously where the nanotube layer 2 is formed directly upon the substrate 1, for example by catalyst initiated CVD.

Functionalization or Recognition Layer. The sensor functionalization material 120 may be selected for a specific application, such as to interact with a targeted analyte 101 to cause a measurable change in electrical properties of nanosensor device 102. For example, the functionalization material 120 may cause an electron transfer to occur in the presence of analyte 101, or may influence local environment properties, such as pH and the like, so as to indirectly change device characteristics. Alternatively or additionally, the recognition material may induce electrically-measurable mechanical stresses or shape changes in the nanostructure channel 106 upon interaction with a target analyte. Sensitivity to an analyte or to multiple analytes may be provided or regulated by the association of a nanotube conducting channel 106 with an adjacent functionalization material 120. Specific examples of suitable functionalization materials are provided later in the specification. The functionalization material 120 may be disposed as a continuous or discontinuous layer on or adjacent to channel 106.

Functionalization material 120 may be selected for a wide range of alternative chemical or biomolecular analytes. Examples include functionalization specific to gas analytes of industrial or medical importance, such as carbon dioxide as disclosed in application Ser. No. 10/940,324 filed Sep. 13, 2004 entitled “Carbon Dioxide Nanoelectronic Sensor”, which is incorporated herein by reference. See also application Ser. No. 10/656,898 referenced hereinabove. Examples of functionalization materials specific to biomolecules, organisms, cell surface groups, biochemical species, and the like are disclosed in application Ser. No. 10/345,783, filed Jan. 16, 2003, entitled “Electronic Sensing Of Biological And Chemical Agents Using Functionalized Nanostructures” (now published as US 2003-0134433), and in application Ser. No. 10/704,066 referenced hereinabove, both of which applications are incorporated herein by reference.

Functionalization material 120 may comprise as little as a single compound, element, or molecule bonded to or adjacent to the nanostructure channel 106. In addition, or in the alternative, functionalization materials may comprise a mixture or multilayer assembly, or a complex species (e.g., including both synthetic components and naturally occurring biomaterials).

Further examples and more detailed disclosures regarding functionalization materials are disclosed in application Ser. No. 10/388,701, filed Mar. 14, 2003 entitled “Modification Of Selectivity For Sensing For Nanostructure Device Arrays” (published as US 2003/0175161), and in application Ser. No. 60/604,293, filed Nov. 19, 2004, entitled “Nanotube Sensor Devices For DNA Detection”, which applications are incorporated herein by reference. Functionalization material 120 and other sensor elements may be selected to suit various physical forms of sample media, such as gaseous or liquid analyte media. See, for example, application Ser. No. 10/773,631, filed Feb. 6, 2004 entitled “Analyte Detection In Liquids With Carbon Nanotube Field Effect Transmission Devices”, and application Ser. No. 60/604,293, filed Nov. 13, 2004, entitled “Nanotube Based Glucose Sensing,” both of which applications are incorporated herein by reference.

Alternative Substrate elements. Optionally, the substrate may include integrated temperature management elements such as a microfabricated heater structure, a Peltier type micro-cooler, thermal isolation bridges, thermister/microprocessor feedback controller, and the like. Note that thermal control may be used to achieve a wide variety of sensor performance goals. For example, temperature control can be used to increase response rate by accelerate analyte reactions; to improve sensor recovery time by evaporating prior analyte or reaction products; by optimizing reactions (e.g., DNA hybridization, stringency controls); by evaporating condensed media vapors; and the like. Likewise, other advantageous processing, power supply or support circuitry may be integrated on a sensor chip.

See U.S. patent application Ser. No. 10/655,529 filed Sep. 4, 2003 entitled “Improved Sensor Device With Heated Nanostructure”, which is incorporated by reference. See also suitable micromachining and/or etching techniques are described in A. Tserepi et al, “Fabrication of suspended thermally insulating membranes using front-side micromachining of the Si substrate: characterization of the etching process”, J. of Micromech. and Microeng, Vol.13, p. 323-329 (2003); C. Tsamis et al, “Fabrication of suspended porous silicon micro-hotplates for thermal sensor applications”, Physica Status Solidi (a), Vol. 197 (2), p. 539-543 (2003); and A. Tserepi et al, “Dry etching of Porous Silicon in High Density Plasmas”, Physica Status Solidi (a), Vol. 197 (1), p.163-167 (2003), each of which publication is incorporated by reference herein.

Optionally, the substrate may include protective and surface conditioning layers. For example a diffusion barrier may be included to prevent contamination of a substrate, such as doped silicon, by metallic catalysts or other substances introduced during fabrication steps. See U.S. patent application Ser. No. 11/111,121 filed Apr. 20, 2005 entitled “Remotely communicating, battery-powered nanostructure sensor devices”; both of which applications are incorporated by reference.

### 3. Sensor Arrays

A plurality of sensor devices 102 may be conveniently arranged as an array embodiment, the array being configured to provide for a number of advantageous measurement alternatives, as described in the patent applications incorporated by reference above. A number of different measurement methods and benefits are enabled by a sensor array according to the invention, for example:
a) multiple analytes detected by a plurality of specifically functionalized sensors,
b) increased precision and dynamic range by a plurality of sensors each of which is optimized for a different range,
c) increased analyte specificity and flexibility by detecting a characteristic “profile” of responses of a target analyte to a plurality of differently-functionalized sensors,
d) self calibration systems and isolated reference sensors,
e) multiple-use array having a plurality of deployable one-time-use sensor sub-units, or
f). ultra-low-cost, direct-digital-output sensor arrays, including a plurality of sensors, each producing a binary signal, and collectively having a range of response thresholds covering a selected analyte concentration range.

The nanoelectronic sensors having aspects of the invention are inherently suitable to array configurations, such as may be employed in the multi-analyte integrated breath analysis system described herein. These sensors and sensor arrays can be fabricated by a range of known manufacturing technologies (see U.S. patent application Ser. No. 10/846,072 entitled “Flexible Nanotube Transistors” which is incorporated herein).

One preferred approach is to use the wafer processing technology developed for the semiconductor electronics industry. This approach not only permits many sensors to be made on as single chip, but permits sensors of different functional types and different architectures to be produced simultaneously on a common substrate, using appropriate photolithographic techniques, masking, controlled etching, micro-machining, vapor deposition, “ink jet” type chemical application and circuit printing, and the like, to produce the elements of the various sensor devices and associated circuitry.

### 4. Measurement Systems

The electronic circuitry described in this example is by way of illustration, and a wide range of alternative measurement circuits may be employed without departing from the spirit of the invention. Embodiments of an electronic sensor device having aspects of the invention may include an electrical circuit configured to measure one or more properties of the nanosensor 120, such as measuring an electrical property via the conducting elements 110, 112. For example, a transistor sensor may be controllably scanned through a selected range of gate voltages, the voltages compared to corresponding measured sensor current flow (generally referred to herein as an I-V_{g} curve or scan). Such an I-V_{g} scan may be through any selected gate voltage range and at one or more selected source-drain potentials. The V_{g} range is typically selected from at least device “on” voltage through at least the device “off” voltage. The scan can be either with increasing V_{g}, decreasing V_{g}, or both, and may be cycled positive or negative at any selected frequency.

In addition to the transconductance/NTFET example of FIG. 1, it should be understood that alternative embodiments of an electronic sensing device for detecting an analyte having aspects of the invention may include sensors configured with other architectures and for measurement of other properties. Any suitable electrical or magnetic property may provide the basis for sensor sensitivity, for example, electrical resistance, electrical conductance, current, voltage, capacitance, impedance, inductance, transistor on current, transistor off current, and/or transistor threshold voltage. In the alternative, or in addition, sensitivity may be based on a measurements including a combination of properties, relationships between different properties, or the variation of one or more properties over time. For example, a sensor embodiment may include circuitry and elements configured and optimized for measurement of capacitance relative to a nanostructured sensor element, for example, the response of the capacitance of a functionalized nanotube network to interaction with an analyte of interest.

Note that a sensor system may include suitable circuitry to perform measurement of more than one property of a single electronic sensor device. For example, a sensor device configured as a FET may have (a) resistance or conductance measurements performed across the conductive channel element, (b) channel resistance or conductance may be measured under the influence of constant or variable gate voltage, (c) a capacitance or impedance of the device measured relative to the gate electrode and the conductive channel, (d) time integrated characteristics such as hysterisis, phase shifts, recovery behavior, or like properties or combinations thereof. The use of multiple measurement strategies using a single sensor on a real-time basis allows increased accuracy, sensitivity and selectivity.

From such measurements, and from derived properties such as hysteresis, time constants, phase shifts, or scan rate/frequency dependence, correlations may be determined with target detection or concentration. The electronic sensor device may include or be coupled with a suitable microprocessor or other computer device as known in the art, which may be suitably programmed to carry out the measurement methods and analyze the resultant signals. Those skilled in the art will appreciate that other electrical or magnetic properties may also be measured as a basis for sensitivity. Accordingly, the embodiments disclosed herein are not meant to restrict the types of device properties that can be measured.

Optionally, the measurement circuitry may be configured so as to provide compensation for such factors as temperature and pressure and humidity. See U.S. patent application Ser. No. 11/111,121 filed Apr. 20, 2005 entitled “Remotely communicating, battery-powered nanostructure sensor devices”; both of which applications are incorporated by reference.

### 5. CO₂ Sensor Example

In an exemplary embodiment of a carbon dioxide (CO₂) sensor (see schematic of FIG. 1), sensitivity to CO₂ may be achieved using a suitable functionalization material or layer 120 (which may be continuous or discontinuous). The functionalization layer may perform two main functions: 1) to selectively recognize carbon dioxide molecules and 2) upon the binding of CO₂ to generate an amplified signal that is transferred to the carbon nanotube transducer. In the presence of water, carbon dioxide forms carbonic acid which dissociates and alters the pH of the functionalization layer, thus protonating the electron donating groups and making the NTFET more p-type. Basic inorganic compounds (e.g., sodium carbonate), pH-sensitive polymers, such as polyaniline, poly(ethyleneimine), poly(o-phenylenediamine), poly(3-methylthiophene), and polypyrrole, as well as aromatic compounds (benzylamine, naphthalenemethylamine, antracene amine, pyrene amine, etc.) may be used to functionalize NTFETs for CO₂ sensing. The functionalization layer may be constructed using polymeric materials such as polyethylene glycol, poly(vinyl alcohol) and polysaccharides, including various starches as well as their components amylose and amylopectin.

Functionalization material 120 may comprise more than one material and/or more than one layer of material, also referred to as “functionalization material”, “functionalization layer” or “functionalization”. The functionalization layer has two main functions: 1) it selectively recognizes carbon dioxide molecules and 2) upon the binding of CO₂ it generates an amplified signal that is transferred to the nanostructure (e.g., carbon nanotube) transducer. Basic inorganic compounds (e.g., sodium carbonate), pH-sensitive polymers, such as polyaniline, poly(ethyleneimine), poly(o-phenylenediamine), poly(3-methylthiophene), and polypyrrole, as well as aromatic compounds (benzylamine, naphthalenemethylamine, anthracene amine, pyrene amine, etc.) can be used to functionalize NTFETs for CO₂ sensing. The functionalization layer can be constructed using certain polymeric materials such as polyethylene glycol, poly(vinyl alcohol) and polysaccharides, including various starches as well as their components amylose and amylopectin. For example, a suitable reaction layer may be formed from a combination of PEI or similar polymer with a starch polymer. Other suitable materials for the functionalization layer may include, for example, metals, metal oxides, and metal hydroxides. In addition, a metallic functionalization layer may be combined with a polymeric functionalization layer.

Materials in the functionalization layer may be deposited on the NTFET using various different methods, depending on the material to be deposited. For example, inorganic materials, such as sodium carbonate, may be deposited by drop casting from 1 mM solution in light alcohols. The functionalized sensor may then be dried by blowing with nitrogen or other suitable drying agent. Polymeric materials may be deposited by dip coating. A typical procedure may involve soaking of the chip with the carbon nanotube device in 10% polymeric solution in water for 24 hours, rinsing with water several times, and blowing the chip dry with nitrogen. Polymers which are not soluble in aqueous solutions may be spin coated on the chip from their solutions in organic solvents. Values of polymer concentrations and the spin coater's rotation speeds may be optimized for each polymer.

In one exemplary embodiment having aspects of the invention, the functionalization layer 815 includes PAMAM or poly(amidoamine) dendrimer, which has a branched structure suitable for formation of hydrogels. PAMAM is available commercially in a number of types and forms, such as from Dendritic NanoTechnologies, Inc.; Dendritech, Inc; and Sigma-Aldrich Co. For example, an ethylenediamine core may have poly(amidoamine) branches with terminal amine groups. See Xu-Ye Wu, Shi-Wen Huang, Jian-Tao Zhang, Ren-Xi Zhuo, “Preparation and Characterization of Novel Physically Cross-linked Hydrogels Composed of Poly(vinyl alcohol) and Amine-Terminated Polyamidoamine Dendrimer”, Macromol. Biosci. 2004, 4, 71-75, which is incorporated by reference.

Functionalization material 120 may be comprised so as to balance hydrophobicity, hydrophilicity and basic properties (e.g., amino polymers), so as to optimize response time and cross-sensitivity to other species in the sample environment, such as relative humidity. The use of thin film coatings or assembled monolayers (SAM) can be employed to improve response time.

Alternative materials for layer 120 may include, for example, those shown in TABLE 1. Such materials may be included in sensors such as are describe herein without departing from the spirit of the invention.

TABLE 1
Examples of alternative recognition materials

| | |
|---|---|
| V₂O₅ | WO₃ |
| Polyacrylic acid | Polyurethane resin |
| Poly(acrylic acid-co-iso- | Polycarbazole |
| octylacrylate) | |
| poly(ethylene imine), “PEI” | poly(sulfone) |
| poly(4-vinylphenol) | poly(vinyl acetate) |
| poly(alkyl methacrylate) | poly(vinyl alcohol) |
| poly(a-methylstyrene) | poly(vinyl butyral) |
| poly(caprolactone) | polyacrylamide |
| poly(carbonate bisphenol A) | polyacrylonitrile |
| poly(dimethylsiloxane) | polyaniline |
| poly(ethylene glycol) | polybutadiene |
| poly(ethylene oxide) | polycarbonate |
| poly(ethylenimine) | polyethylene |
| poly(methyl vinyl ether-co- | polyoxyethylene |
| maleic anhydride) | |
| poly(N-vinylpyrrolidone) | polypyrrole |
| poly(propylene) | polytetrafluoroethylene |
| poly(styrene) | polythiophene |
| polyvinyl-methyl-amine | Polyvinyl pyridine |
| polyaminostyrene | |
| Chitosan | chitosan HCL |
| Polyallylamine | polyallylamine HCL |
| poly(diallylamine) | poly(diallylamine) HCL |
| poly(entylene-co-vinyl | poly-(m-aminobenzene sulfonic |
| acetate), ˜82% ethylene | acid), “PABS” |
| poly(styrene-co-allyl | poly(vinyl chloride-co-vinyl |
| alcohol), ˜5.7% hydroxyl | acetate), ˜10% vinyl acetate |
| poly(styrene-co-maleic | poly(vinylidene chloride-co- |
| anhydride), ˜50% styrene | acrylonitrile), ˜80% vinylidene |
| | chloride |

Materials in the functionalization layer may be deposited on the NTFET using various different methods, depending on the material to be deposited. For example, inorganic materials, such as sodium carbonate, may be deposited by drop casting from 1 mM solution in light alcohols. The functionalized sensor may then be dried by blowing with nitrogen or other suitable drying agent. Polymeric materials may be deposited by dip coating. A typical procedure may involve soaking of the chip with the carbon nanotube device in 10% polymeric solution in water for 24 hours, rinsing with water several times, and blowing the chip dry with nitrogen. Polymers which are not soluble in aqueous solutions may be spin coated on the chip from their solutions in organic solvents. Values of polymer concentrations and the spin coater's rotation speeds may be optimized for each polymer.

FIG. 2 is a plot showing the response of an exemplary nano-electronic carbon dioxide sensor having aspects of the invention to a wide and high range of concentrations of carbon dioxide in air, ranging from 500 to 100,000 ppm (0.5%-10%). The sensor shows a wide dynamic range and the response to CO₂ gas is fast and reproducible at different concentrations.

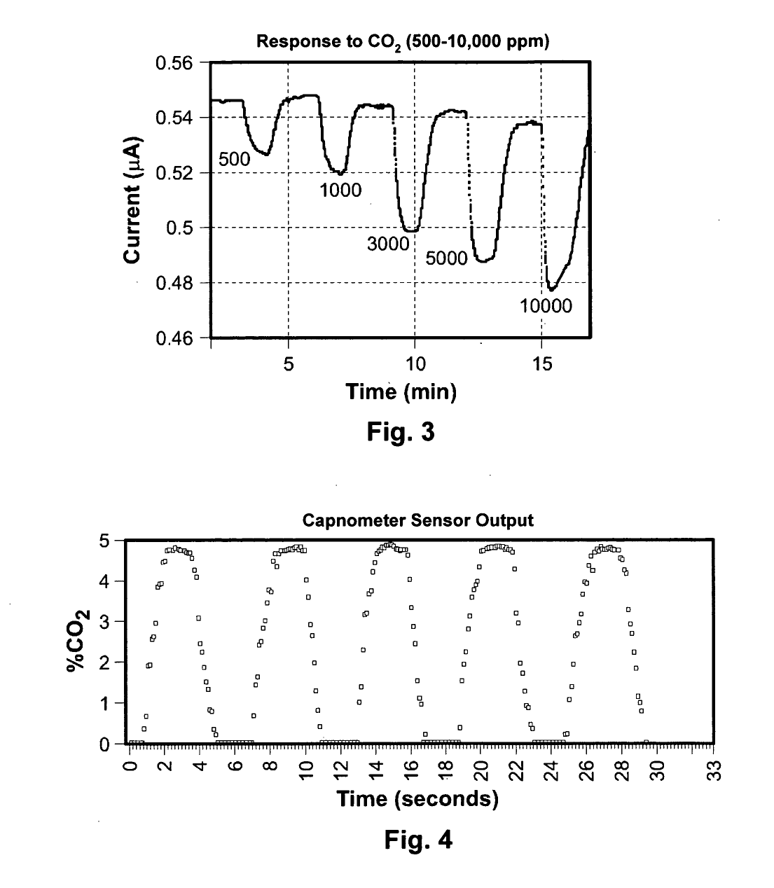

FIG. 3 is a plot showing the response of an exemplary nano-electronic carbon dioxide sensor having aspects of the invention to a low range of concentrations of carbon dioxide in air. The sensor shows wide dynamic range in the concentration range of 500 to 10,000 ppm. Suitable recognition chemistry and specificity permit the sensor to operate at different relative humidities and shows low cross-sensitivity to anesthesia gases (oxygen and nitrous oxide).

FIG. 4 is a capnogram plot showing the response of an exemplary capnometer having aspects of the invention to simulated human breathing. The performance of the sensor at this clinically relevant condition shows the great potential for these sensors in capnography and anesthesia medical applications.

Further aspects of a nanosensor for sensing carbon dioxide are disclosed in application Ser. No. 10/940,324 filed Sep. 13, 2004 entitled “Carbon Dioxide Nanoelectronic Sensor,” which is incorporated herein, in its entirety, by reference.

### 6. NO Sensor Example

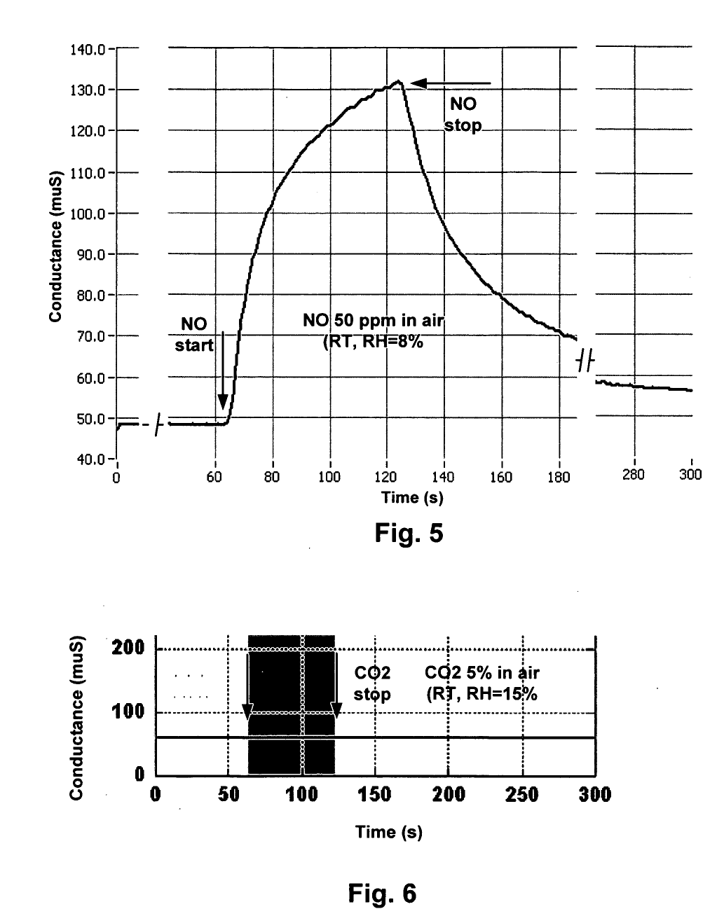

FIG. 5 shows a plot of the response of an exemplary nanostructure sensor, having aspects of the invention to a short exposure to NO in air at 50 ppm concentration (room temperature and an relative humidity of 8%). The results shown are for the response to nitric oxide of the functionalized NTFET devices as packaged devices (See packaged device 100′ in FIG. 1B). In these measurements packaged devices were tested in a flow cell at controlled humidity and at a selected concentration of NO gas balanced with air. Functionalized NTFET devices have showed reliable responses to NO gas in air at ambient conditions as low as 50 ppm. The degree of response indicates that much lower thresholds are possible, e.g. in the low ppb regime.

As shown in FIG. 6, the NO sensor device shows little or no cross sensitivity to CO₂, an interferant in breath. In this case, the device was exposed (room temperature and an relative humidity of 8%) to a CO₂ concentration of 5%, representative of exhaled human breath.

In this example, the sensor platform employed includes a field effect transistor (FET) made from semiconducting single-walled carbon nanotubes (NTFETs) (see schematic of FIG. 1A). While unfunctionalized NTFET devices are sensitive but not specific to strong electron donating and accepting gases (NO, NO₂, NH₃), a functionalize NTFET devices have been found to be specific to nitric oxide gas. The functionalization layer has two main functions: 1) it selectively recognizes nitric oxide molecules and 2) upon the binding of NO it generates an amplified signal that is transferred to the carbon nanotube transducer. Thus the surface modification provides the sensitivity and the selectivity of the NTFET for NO quantification at the low concentration levels.

The functionalization approach relies on the ability of basic inorganic compounds and organic polymers, aromatic compounds, biological relevant molecular receptors with possible electron-donating functionalities to provide electrons to nanotubes, thus resulting in preferred doping of NTFETs. To this end, electropolymerization and/or deposition of suitable electroactive species is employed to form thin, stable, and reproducible films on carbon nanotube network. Moreover, the rate and extend of polymerization and thus the thickness and physicochemical properties of the resulting electrodeposited film, can be accurately controlled by careful monitoring of the electrochemical parameters.

In the case of NO detection, materials that may be used for carbon nanotube surface modification include numerous metal complexes of porphyrins and phthalocyanines as well as conducting polymers, such as polyaniline and polypyrrole. The recognition of NOx molecules can be also achieved by using amino-containing polymers, i.e., poly(ethyleneimine), bis-amino terminated poly(ethylene glycol), as well as such aromatic compounds as (benzylamine, naphthalenemethylamine, calix[4]arenes, and the like). It should also be noted that alternative sensor embodiments for detection of NO may employ methods of oxidation of NO in a sample, without departing from the spirit of the invention. For example, NO may be oxidized (e.g., using a catalyst) to form NO₂, followed by detection of the resultant NO₂ using a sensor configured to have a sensitivity to NO₂.

### Capacitive Sensor Example

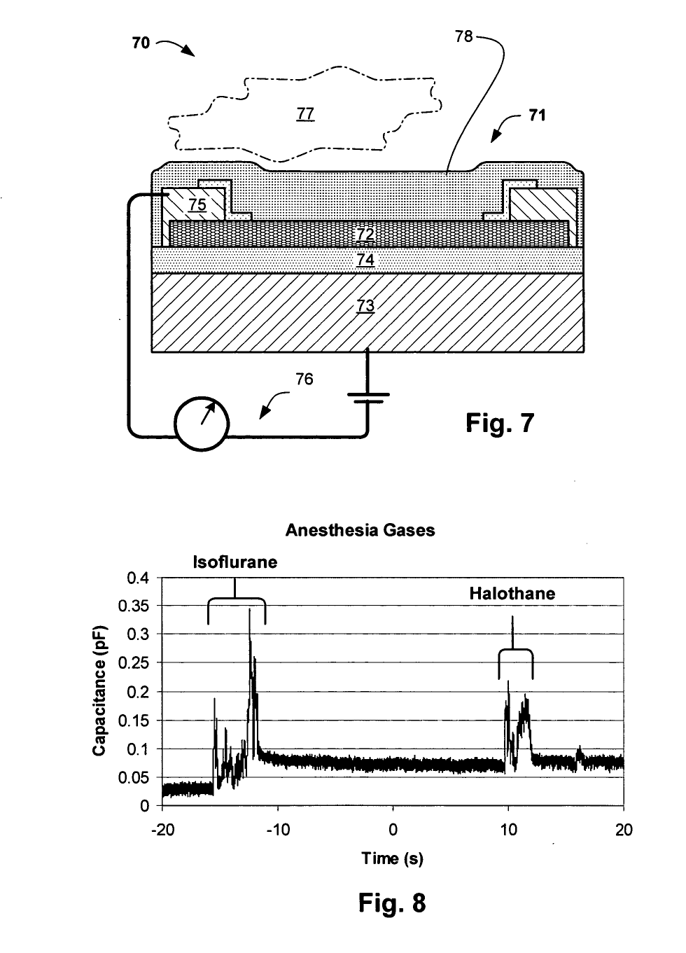

FIG. 7 shows a schematic of an exemplary sensor device 70 having aspects of the invention, including a nanostructure sensor 71 fabricated in a manner generally as described for the sensor shown in FIG. 1 above. Sensor 71 includes a nanostructure conductive element 72, in this example a carbon nanotube network, disposed upon a substrate comprising a dielectric isolation layer 74 disposed upon a base 73, in this example a doped silicon wafer back gate. The nanotube network 72 is contacted by at least one conductive electrode 75 (a pair are shown, in this case having optional passivation on the electrode-nanotube contact region). The sensor device 70 further includes at least a capacitance measurement circuit 36 in electrical communication with contact 75 and back gate 73, so as to permit the capacitance and/or impedance of the spaced apart nanotube network/back gate assembly to be readily measured (i.e., the total charge required to be placed on either conductor to create a given voltage potential between conductors, C=Q/V).

It should be understood that other capacitor conductors may be substituted for backgate counter-electrode 73 without departing from the spirit of the invention, such as a top counter-electrode, liquid counter-electrode, a second spaced-apart nanotube network conductor, and the like. The effect of the counter electrode is to induce an electric field potential between the counter electrode and the nanostructure electrode (e.g. nanotube network), so that capacitance can be measured, and thus the change of capacitance in response to interaction of one or more analytes of interest can be determined. Typically, the analyte can induces a change in the effective dielectric constant in the separation space between the electrodes. Additionally, many alternative functional configurations of the respective conductors are possible, including recognition materials which bind or immobilize an analyte of interest in relation to the electrodes.

The capacitance C of the sensor 71 may be calibrated, and compared analytically with the capacitance during exposure to analyte of interest 11 (e.g., isoflurane, halothane, and the like). In particular, species having significant dipole moments may act to change the capacitance upon interaction with the nanotube network 72.

FIG. 8 shows a plot of the response of an exemplary nanostructure capacitance sensor, such as is shown in FIG. 7, to a airway analyte, in this example, anesthesia agents. FIG. 8 shows sensor response during brief exposure (in the presence of ambient air) to isoflurane, followed by a recovery period, and then subsequent exposure to halothane. In this example, the nanotube network 72 of sensor 71 was directly exposed to the analyte media. Note that the rapid variation of amplitude of capacitance in FIG. 8 is due, not to noise, but to turbulent mixing of the analyte with the sample media in the vicinity of the sensor. Response to a constant analyte concentration does not show this effect. Indeed, FIG. 8 demonstrates that the sensor response is extremely rapid and sensitive to the analytes tested.

Preferably additional functionalization 78 is included in sensor 71 (e.g., an absorbent filter, a selectively permeable polymer layer, a selectively reactive or binding species, etc., to enhance selectivity, sensitivity and/or signal strength). See, for example, U.S. Provisional Application No. 60/669,126, filed Apr. 6, 2005, entitled “Systems Having Integrated Cell Membranes And Nanoelectronics Devices, And Nano-Capacitive Biomolecule Sensors”, which is incorporated by reference.

### 8. Integrated Multi-Analyte Breath Analysis System

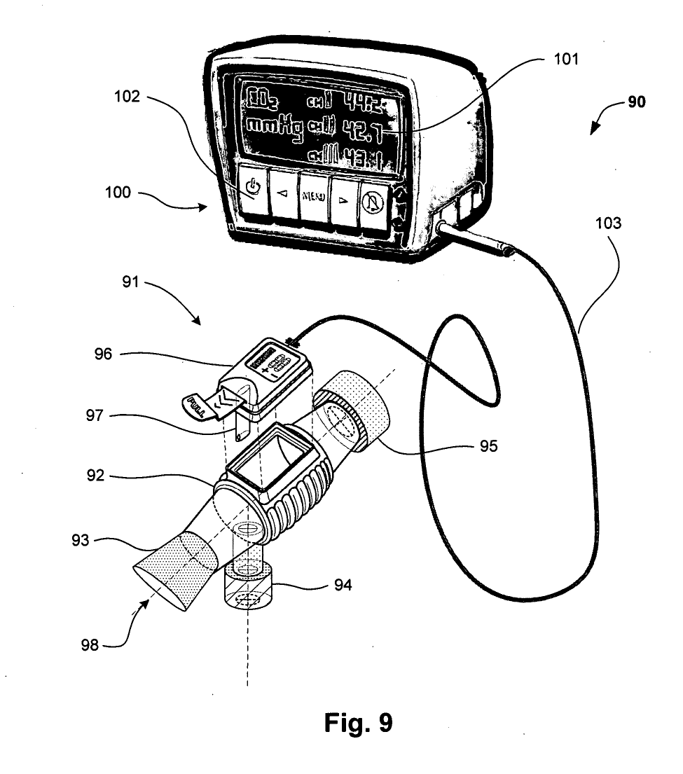

FIG. 9 shows an exemplary integrated multi-analyte breath analysis system 90 having aspects of the invention. As a general description of the layout of this example embodiment, the system 90 comprises a breath sampler 91 and an analyzer-processor-I/O unit 100 communicating with the sampler 91 by signal cable 103. Sampler 91 includes a sampler body 92 having a central lumen 98 in communication with mouthpiece 93. In operation, inspired air is feed into the central lumen 98 via attached inflow valve/filter 94, and conducted via mouthpiece 93 into a patients mouth upon inhalation. Upon exhalation, the patient's breath flows via mouth piece 93 through central lumen 98 and exits through outflow controller 95. During exhalation (and optionally during inhalation), at least one and preferably a plurality of breath constituent species are measured by sensors (see further discussion below), which in this example are mounted in a detachable multi-sensor unit 96, which is shown communicating with central lumen 98 via collector tube 97. One or more measurement signals are transmitted by the multi-sensor unit 96 vial signal cable 103 to analyzer-processor-I/O unit 100.

Note that the breath flow geometry shown in FIG. 9 is but one example having aspects of the invention, and alternative flow arrangements are possible without departing from the spirit of the invention. For example, alternatively inspiration could be through a separate device, via routing valves and tubes (not shown), via nasal inhalation, or even by removal of the mouthpiece from the patients mouth. However, it is preferred to maintain both inhalation and exhalation systematically controlled by the sampler 91, and to avoid flow through the nasal cavity. Note that the filter of inflow valve/filter 94 includes an optional filter or absorbent material to remove potential contaminants from inspired air which could bias the measurements, for example atmospheric NOx. As an alternative to mouthpiece 93, various forms of masks, tracheal tubes and the like as are known in the art may be substituted as the collection component for exhaled breath.

The volume of central lumen 98 is preferably minimal, so as to reduce device dead space, and the inflow valve/filter 94 and the outflow controller 95 preferable include one-way valves or the equivalent to prevent backflow, i.e., inspiration is substantially only via inflow valve/filter 94 and exhalation is substantially only via outflow controller 95, so as to minimize rebreathing.

Likewise, alternative sensor arrangements are possible without departing from the spirit of the invention. For example, sensors could alternative be mounted apart from sampler 91, for example in analyzer unit 100, communication with sampler 91 via extended air sample tubes (not shown). In another alternative, sensors may be mounted within mouthpiece 93, or in an extension tube within the patients mouth or throat.

The example of sampler 91 shown has the advantage that the sensors of detachable multi-sensor unit 96 are arranged very close to the patient's mouth, minimizing measurement time lag and dead space, while conveniently permitting either sensors or the entire sensor unit to be replaced, as needed. The arrangement provides a high degree of operational flexibility to respond to the sometimes competing needs of low cost, simplicity, avoidance of contamination, and maintaining sensor accuracy. For example, it may be desired to have the sampler body 92 and/or intake valve 94 be conveniently patient-washable, while making the multi-sensor unit 96 and/or outflow controller 95 removable so as to protecting them from washing solutions.

Flow controller 95 is preferably configured to manage the exhalation rate during measurements, so as to maintain a generally constant exhalation rate, to maximize consistency and reproducibility of species measurements. Flow controller 95 is also preferably adjustable or pre-set to maintain a selected exhalation rate (and/or a selected flow resistance or other flow parameter) so as to maximize sensitivity and selectivity in sampling of trace species (see further discussion below). Preferably, the exhalation rate may be adjusted to suit patients of different sizes or ages, etc.

In certain alternative embodiments, the outflow controller may be automatically or remotely controlled. For example, the flow controller 95 may permit a variable exhalation rate, establishing a first flow rate at the beginning of a exhalation, and a different or profiled-variable exhalation flow rate as the exhalation phase proceeds. In addition, certain alternative embodiments have one or more remotely operated actuators in the flow controller 95, for example, to permit the exhalation rate (or other flow parameter) to be advantageously adjusted by signals from a processor in analyzer-processor-I/O unit 100. Thus, for example, the measurement routine may be processor-regulated so that a particular exhalation rate or rate profile is are selected to maximize sensitivity for a particular analyte, to maximize discrimination between analyte sources (e.g., distinguishing between bronchial and alveolar contributions to exhaled NO), to select different exhalation rates on successive exhalation phases, and the like.

Analyzer-processor-I/O unit 100 preferably includes at least one display 101 or other output device for communicating with a patient or operator (an LCD display is shown), and also preferably includes at least one user input device 102 (several buttons are shown) to permit convenient patient inputs. In addition, analyzer-processor-I/O unit 100 may include conventional components, such as power supplies, batteries, cable connectors, and the like, common to consumer operated electronic devices. The Analyzer-processor-I/O unit 100 preferably includes signal analyzer to maximize the medical utility and relevance of the measurements of multi-sensor unit 96, as well as memory to maintain a measurement history (which may be patient-specific for more than one patient).

In certain alternatives, the Analyzer-processor-I/O unit 100 may include circuitry to provide wireless and/or internet connectivity, for example to permit medical practitioner to monitor patient-specific measurements remotely, to remotely program the processor/memory to change the measurement routines and parameters in light of patient measurements, to transmit advice re responsive medication dosages, and the like.

### 9. CO₂ Breath Analysis

As noted above, CO₂ measurement is an important indicator of pulmonary and circulatory function. In particular time-domain measurements and profiles of the concentrations of breath species are medically useful indicators which have been correlated with particular medical conditions. For example, aspects of the measured profile of a patient's capnogram (the CO₂ concentration in exhaled breath versus exhalation time) have been correlated with such conditions as bronchial spasms, asthma, obstructive lung disease, restrictive lung disease, and the like. It has also been demonstrated that the profile of a capnogram can be correlated with real-time expiratory flow rate and other spirometric parameters.

See, for example, D. Hampton et al., U.S. Pat. No. 6,648,833 entitled “Respiratory analysis with capnography”; B. You et al., “Expiratory capnography in asthma: evaluation of various shape indices”, Eur Respir J. (1994);7(2) pp. 318-23; M. Yaron et al., “Utility of the expiratory capnogram in the assessment of bronchospasm”, Ann Emerg Med (1996) 28(4) pp. 403-7; and B. You et al., “Expiratory capnography in asthma. Perspectives in the use and monitoring in children”, Rev Mal Respir (1992) 9(5) pp. 547-52; each of which publication is incorporated by reference.

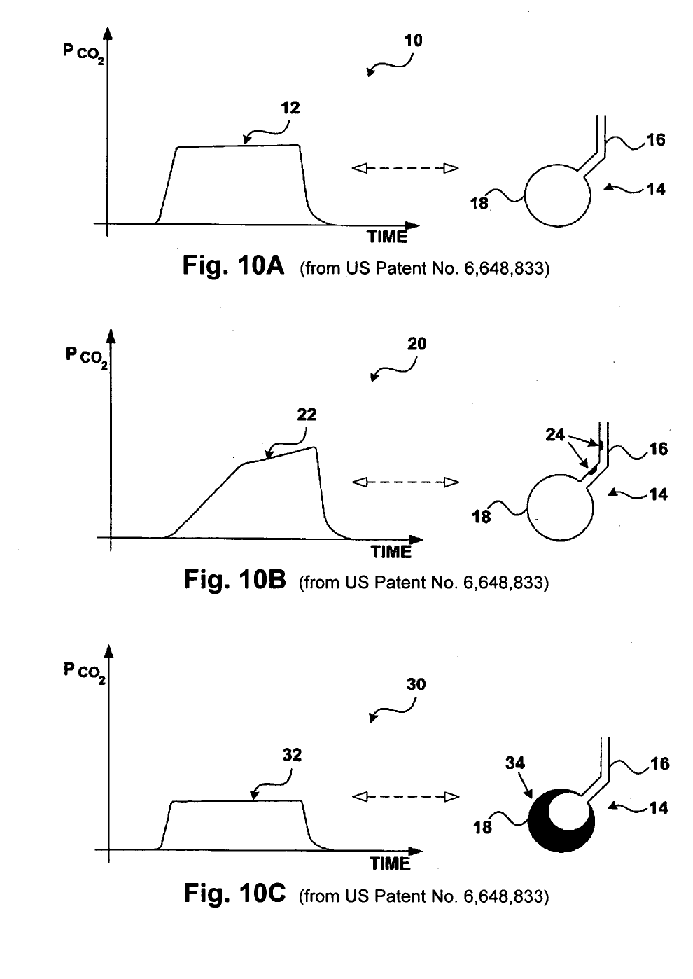

FIGS. 10A-10C (corresponding to FIGS. 1A-C of the above noted U.S. Pat. No. 6,648,833, with the original reference numerals) shows a series of three capnogram plots, each with an respective diagram representative of a patient alveolus status, for both healthy and diseased.

FIG. 10A shows a capnogram 10 for a healthy patient, i.e., a patient with no substantial lung disease. Note that there is an initial lag period when a patient first begins to exhale referred to as “dead space” which represents air expelled from the tracheal and bronchial passages distal to the alveolus (typically approximately 150 mL), in which negligible metabolic CO₂ is exchanged. As breath from alveoli begins to be expelled mixed with air from the dead space, the concentration of carbon dioxide rises, typically in a characteristic, generally linear slope. When the dead space breath is largely expelled, the profile of carbon dioxide concentration flattens to a “plateau” region (although the “plateau” is typically not flat, having a small, characteristic slope), which is maintained until exhalation is complete.

FIG. 10B shows a capnogram 20 for a patient with obstructive lung disease, represented in the diagram by obstructions 24 in airway. Although the alveolar sac 18 may be able to expand and perform gas exchange, the expulsion of breath is hampered by obstructions 24. The plot 20 has a more gradual ascending slope as compared with plot 12 of a normal patient, caused by the inability to exhale rapidly. The patient ventilates adequately in volume, but with difficulty.

FIG. 10C shows a capnogram 30 for a patient with restrictive lung disease, represented in the diagram by restriction 34, such as fibrous tissue, which tends may prevent sac 18 from expanding, and/or may limit the gas exchange. Airway 16 is clear, allowing unimpeded expulsion of breath, but restriction 34 limits the volume of gas in the breath. The plot 30 has generally the same ascending slope as compared with plot 12 of a health patient, but plateaus at a lower concentration when compared to plot 12, indicating that the patient is less adequately ventilated than the healthy patient.

### 10. NO Breath Analysis

As noted above, NO measurement in breath is an important indicator of inflammatory conditions, immune response, and a number of other conditions. In particular, exhaled nitric oxide (NO) has the potential to be an important diagnostic and management indicator for airway diseases and in particular bronchial asthma. Typically, asthmatic patients have high exhaled NO levels as compared non-asthmatic persons, and the administration of effective anti-inflammatory therapy has been correlated with a significant decrease in these NO levels.

Although existing tests of exhaled NO employing expensive, bulking and complex equipment may aid in the diagnosis and assessment of current asthma status in an clinical outpatient setting, what is needed is an inexpensive, truly portable, and patient operable NO monitoring unit to provide typical asthma patients (or their parents or caretakers) with a real-time index of the need for self-administered medication, or response to such therapy. Prompt compliance with a treatment program tailored to the patient's day-to-day (or shorter time scale) status of bronchial inflammation can prevent an asthmatic episode from becoming an emergency matter. In addition, accurate proactive control of chronic inflammatory airway conditions without over-medication can reduce cumulative tissue damage and improve long term patient outcomes.

See, for Example, S. A. Kharitonov et al, “Increased nitric oxide in exhaled air of asthmatic patients”, The Lancet (1994) vol. 343, pp. 133-135; B. Kimberly et al, “Nasal Contribution to Exhaled Nitric Oxide at Rest and during Breathholding in Humans”, Am. J. Resp. Critical Care Med. (1996) 153 pp. 829-836; A. F. Massaro et al, “Expired nitric oxide levels during treatment of acute asthma”, Am. J. Resp. Critical Care Med. (1995) vol. 152, No. 2, pp. 800-803; and P. E. Silkoff et al, “Airway nitric oxide diffusion in asthma: Role in pulmonary function and bronchial responsiveness”, Am. J. Resp. Critical Care Med. (2000) 161 pp. 1218-1228; each of which publication is incorporated by reference.

Unlike CO₂, which is a major component of exhaled breath (typically 1-5%), NO is generally present in only trace amounts, typically in an order of magnitude of a few parts-per-billion (ppb). For example, a non-asthmatic patient may be test for eNO in the range of 5-25 ppb, while an asthmatic patient may test in the 30-100+ ppb range. Of course measurement at these levels requires much greater detector sensitivity than for CO2. But importantly, NO is produced by metabolic processes in many different tissues and cellular responses, which are not negligible, given that trace amounts are medically relevant. In respiration, NO is produced not only in the bronchial airway, and by alveolar gas exchange from the blood, but is also produce in nasal, mouth, tracheal and throat tissue. In addition, NOx of atmospheric and localized air pollution can contribute to measurements. Therefore, substantial work has been done in the attempt to assure that the NO in sampled breath is representative of bronchial airway sources, while minimizing alternative contributions. For example, intake filters may be employed to remove ambient NO from inspired air. Techniques may be employed to exclude air emerging from the nasal cavity via the nasopharynx from the sample. In addition, exhaled NO concentrations depend substantially on expiratory flow rate.

See for example, P. Silkoff et al., “Marked Flow-dependence of Exhaled Nitric Oxide Using a New Technique to Exclude Nasal Nitric Oxide”, Am. J. Respir. Crit. Care Med., (1997)155 pp. 260-67; U.S. Pat. Nos. 5,795,787 and 6,010,459, each entitled “Method and apparatus for the measurement of exhaled nitric oxide in humans”; U.S. Pat. No. 6,067,983 entitled “Method and apparatus for controlledflow sampling from the airway”; U.S. Pat. No. 6,733,463 entitled “Method and measuring equipment for measuring nitric oxide concentration in exhaled air”; and US Published Application No. 2004-0017,570 entitled “Device and system for the quantification of breath gases”; each of which publication and patent is incorporated by reference.

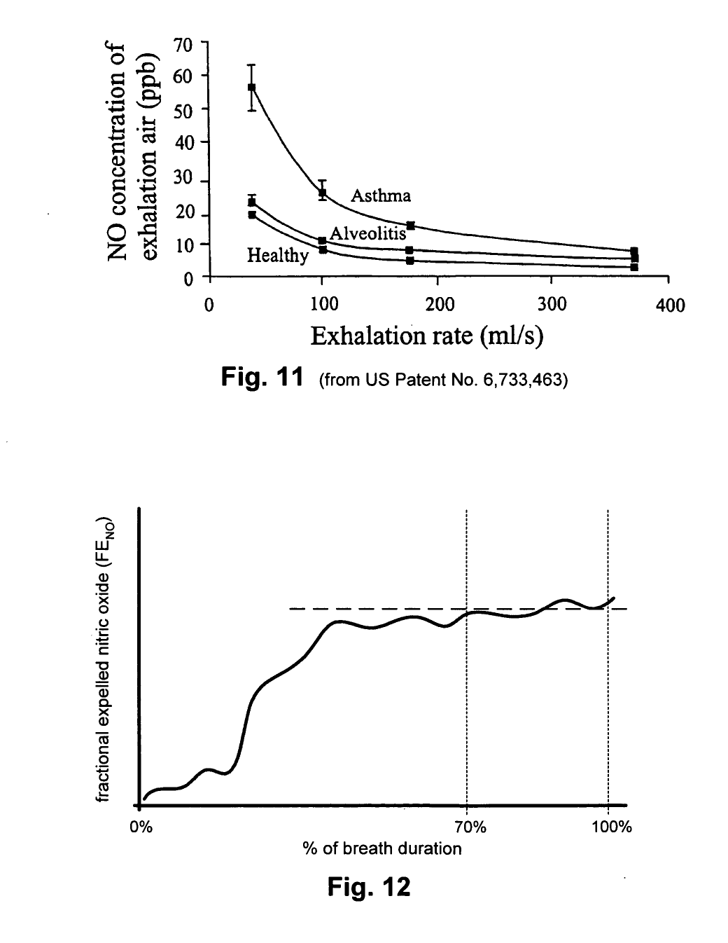

FIG. 11 is a plot showing the dependence of breath NO concentration on the exhalation rate (from the above noted U.S. Pat. No. 6,733,463), comparing healthy patients with patients with airway disease conditions. For all sets of patients, there is a marked, nonlinear reduction in concentration as exhalation rate increases. Give this strong dependence, it is desirable that the exhalation rate be systematically controlled during the measurement process, to give reproducible results which are representative of airway condition, rather than representative of the degree of patient effort or compliance with instructions. It can also be seen in FIG. 11 that although the proportionate effect of exhalation rate on concentration is generally the same for each patient population, the absolute differences in patient population (in ppb) are greatest at the lowest exhalation rate.

FIG. 12 is a plot showing the concentration of exhaled breath NO as a function of time or breath duration. Note that the fractional NO concentration reaches a plateau generally similar in shape (although much lower in concentration) to that of the CO2 capnogram of FIG. 9A. It should be recalled that unlike CO2 (which in exhaled breath is almost entirely for alveolar source), NO in exhaled breath can be supplied as a significant fraction from a number of tissues, so that the profile, such as FIG. 12, varies with sampling factors and flow rate.

### 11. Multiple Breath Gas Analysis

The measurement of different constituents of exhaled breath may be interrelated in a number of ways. For example, CO₂ measurements may be used to confirm breath sampling status (e.g., whether or not sample is from a bronchial source; confirm placement of intake device, confirm exclusion of nasal sources, and the like) prior to analysis for another gas or species, such as NO (see the above referenced U.S. Pat. No. 6,010,459).

In addition, CO₂ breath profile can be correlated with exhalation flow rate, and thus may be employed in managing sampling procedure for sampling of trace species, such as NO, which show marked dependence on exhalation rate (see the above referenced U.S. Pat. No. 6,648,833). Simultaneous CO₂ measurements can provide useful estimates of a number of related spirometric parameters.

Metabolically, one breath constituent may exercise a regulatory effect on another. For example, it has be shown that CO₂ may have a regulatory or feedback effect on exhaled NO in mammals (e.g., exhaled NO can be depressed by inhaled CO₂), the effect being independent of the central nervous system and changes in extracellular pH (see L. C. Adding et al, “Regulation of pulmonary nitric oxide by carbon dioxide is intrinsic to the lung”, Acta Physiol Scand. (1999) 167 (2) pp. 167-174; which is incorporated by reference). It has also been shown that while high alveolar CO₂ inhibits exhaled NO, increases in blood concentration of CO₂ do not have this effect. It has been suggested that alveolar CO₂ inhibits epithelial NO synthase activity noncompetitively and that the suppressed NO production by hypercapnia augments hypoxic pulmonary vasoconstriction (see Y. Yamamoto et al, “Role of airway nitric oxide on the regulation of pulmonary circulation by carbon dioxide”, J Appl Physiol (2001) 91:3 pp.: 1121-1130).

Measurement of additional breath species may improve monitoring of patient status. r example, it has exhaled hydrogen peroxide (H₂O₂) and nitric oxide (NO) are elevated in asthmatic patients. Measurement of H₂O₂, NO and eosinophils in induced sputum (carried out on both stable, unstable and healthy patients, and controlled for past use of steroid treatment) showed:
a) both exhaled H₂O₂ and NO levels were elevated in steroid-naive asthmatic patients compared with normal subjects;
b) both exhaled H₂O₂ and NO levels were reduced in stable steroid-treated patients.
c) in unstable steroid-treated asthmatics, however, H₂O₂ levels were increased, but exhaled NO levels were low;
d) expired H₂O₂ correlated with both sputum eosinophils and airway hyperresponsiveness; and
e) in contrast, exhaled NO also correlated with sputum eosinophils, but not with airway hyperresponsiveness.
   Thus, expired H₂O₂ and NO measurement in asthmatic patients can provide complementary data for monitoring of disease activity. I. Horvath et al, “Combined Use of Exhaled Hydrogen Peroxide and Nitric Oxide in Monitoring Asthma”, Am. J. Respir. Crit. Care Med. (1998) Vol. 158, No. 4 pp. 1042-1046).

Simultaneous NO (or other trace species) and CO₂ measurement protocols have been proposed in which the CO₂ concentration in exhaled breath (known or measurable with reasonable accuracy) is employed as an internal standard to reduce measurement error for the NO or other trace gas. Such techniques are largely necessitated by the inherent variations of many conventional measurement systems, such as temperature sensitivity, laser output fluctuations, expensive consumable calibration gases, and the like. See, for example, US Published Application No. 2003-0134,427 entitled “Method and apparatus for determining gas concentration”; and C. Roller et al, “Simultaneous NO and CO₂ measurement in human breath with a single IV-VI mid-infrared laser”, OPTICS LETTERS (2002) Vol. 27, No. 2 pp.107-109, each of which is incorporated by reference. Stable nanoelectronic sensors having aspects of the invention can reduce dependence on such compensation techniques.

It can be seen that the above discussion that the particular features of the multi-valent breath analyzer shown in FIG. 9 suit it to sampling, measuring and analyzing breath gases with substantially different physiological and chemical characteristics, such as CO₂ and NO.

### 12. Sensor-Sampler Configuration Alternatives

Note that the multi-sensor unit 96 is shown in FIG. 9 having a collector tube 97 projecting downward into central lumen 98 of sampler body 92, so. as to carry breath air upward to interact with the sensors of sensor unit 96. A number of alternative arrangement of the sensors in relation to the central lumen are practical, and the choice of particular sensor mounting may be determined to optimize sensor performance, useful life, and the like.

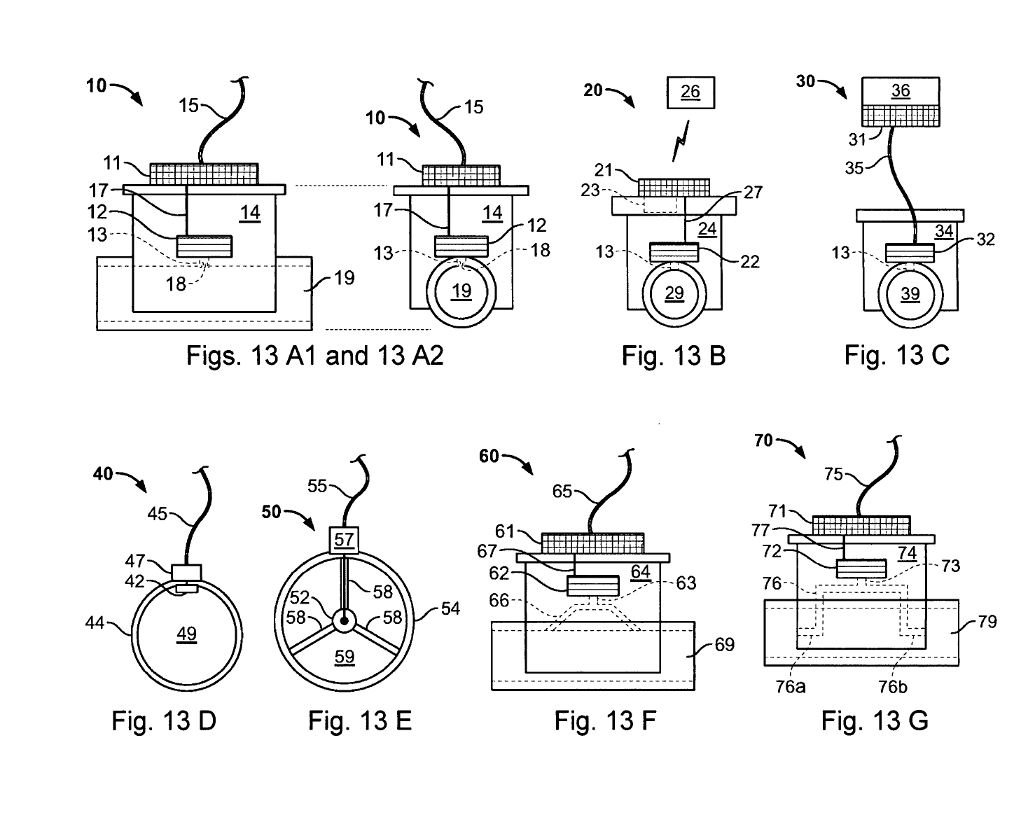

FIGS. 13A through 13G illustrate a number of alternative sensor mounting arrangements that may be employed in breath sampler 91. FIGS. 13A-13G are taken from the above mentioned commonly assigned U.S. patent application Ser. No. 11/019,792 filed Dec. 18, 2004 entitled “Nanoelectronic Capnometer Adapter”, which is incorporated by reference, and illustrate examples of an airway capnometer adapter having certain features and principles of operation generally similar to sampler 91 herein, and which may alternatively be employed therein without departing from the spirit of the invention and without undue experimentation.

Note that while the reference numerals of FIGS. 13A-13G do not generally refer to the same elements as those of other figures herein, in the different embodiments depicted in FIGS. 13A-13G, the same or generally similar elements are identified by numbers, in which the last digit corresponds to the equivalent or corresponding element, as much as possible, in each figure, with the digits preceding the last digit corresponding to the figure number of each example embodiment. In each example of FIGS. 13A-13G, the central lumen 98 (FIG. 9) is represented by a reference numeral ending in 9, in which the exhalation flow passes.

It should be understood that while in the exemplary embodiments described in detail in U.S. patent application Ser. No. 11/019,792, the nanoelectronic sensors included selectivity and sensitivity for CO₂, but the principles of construction and operation apply generally to sensors adapted to other analytes of interest, such as described herein, and apply equally to multi-analyte sensors and sensor arrays having aspects of the invention as are described herein.

Referring first to FIGS. 13A1 and 13A2, in an exemplary embodiment having aspects of the invention, the unit may be configured with an input and output for connecting tubing to an air channel 19 running through a housing 14. The adapter 10 may be connected to a power and signal cable 15. Cable 15 may be used to relay gas monitoring data to the display unit, as well as powering the sensor. The cable may be directly connected to an electronics module 11. This module may be configured for signal processing, analysis, and delivery of data values/waveforms to users. Module 11 contain a microprocessor with embedded software and backup battery power. The electronics module may be located above and connected by connector 17 to a solid-state sensor 12 (e.g., a nanoelectronic capnometer sensor such as is disclosed in application Ser. No. 10/940,324). Module 11 may be configured to readily detach and reattach, facilitating replacement of the sensor-containing adapter 14. Electronics module 11 and sensor 12 may be provided on a single unitary semiconductor device, for example, a silicon chip, if desired. The nanoelectronic sensor 12 may be disposed in fluid communication with respired air passing through channel 19. In order to provide a sample volume to the capnometer, a small window or opening 13 may be provided between the sensor 12 and channel 19. The sample window may be provided with membranes and/or filters 18 to reduce condensation, block patient secretions, and overall maintain stability of the sensor. For example a gas-permeable hydrophobic membrane, e.g. a PFC membrane, may be used.

When using a nanotube electronic sensor, it is not necessary to maintain a clear optical path between a transmitter and receiver, unlike prior-art NDIR sensors for carbon dioxide sensing. Furthermore, the active sensing area of a nanotube sensor is extremely small, so one may readily protect the sensor from contamination in the patient airstream. For example, very little power is required to heat the sensor to a stable temperature at which condensation is prevented. And the sensor may be protected from non-volatile contaminants by a simple mechanical filter and/or gas permeable membrane, which need only be large enough to minimize the likelihood of excessive filter blockage during the anticipated life of the sensor. For reusable sensors, filter units may be removed and disposed between use, and then replaced with a new filter unit. For most applications, however, it may be desirable to dispose and replace the entire unit 10, including any associated filters. The unit 10 may be comprised primarily of a mechanically stable housing 14. Housing 14 may be comprised of any suitable plastic or other material with similar chemical and physical properties for use in medical tube fittings, as known in the art.

The capnometer sensor 12 may be based on nanoscale components as described in the parent patent application Ser. No. 10/940,323 and herein, for selectively sensing carbon dioxide. Sensing of other gases may also be achieved using a suitably configured nanotube sensor, for example, a sensor as described in U.S. provisional applications Ser. No. 60/457,697 filed March 2003 and Ser. No. 60/468,621 filed May 2003, and U.S. non-provisional applications Ser. No. 10/177,929 filed Jun. 2002, Ser. No. 10/656,898 filed Sep. 5, 2003, Ser. No. 10/655,529 filed Sep. 4, 2003, Ser. No. 10/388,701 filed Mar. 14, 2003, and Ser. No. 10/345,783 filed Jan. 16, 2003; each of which is incorporated herein by reference.

Sensing for two or more gases, for example, carbon dioxide and oxygen, may be accomplished using one or more sensors like sensor 12. A single sensor may include a plurality of nanotube sensors, each configured to sense a different gas. In addition, or in the alternative, a plurality of nanotube sensors may be each configured to sense the same gas, for purposes of redundancy. It should be appreciated that the extremely small scale of a nanotube sensor makes it possible to cost-effectively incorporate numerous nanometer-scale sensors in a single gas sensing unit 12, which may essentially consist of a very compact silicon chip or other device. In the alternative, one or more nanotube sensing devices may be assembled together into a sensing unit with multiple sensors. Since each device may be quite small, space and/or cost need not be limiting concerns.

A capnometer according to the invention may readily be configured to operate wirelessly. FIG. 13B shows a wireless unit 20 without a need for a power or signal cable. To compensate for this alteration, one can implement wireless communication capabilities into the electronics module 21 for wireless communication to a base station 26. Since the capnometer 22 uses little power, an on-board miniature battery 23 may provide sufficient power for its lifetime. Housing 24 and channel 29 may be configured similarly as in capnometer 10.

In the alternative, a capnometer 30 may be designed to function with all electronics 31 separate from the sensor 32, as shown in FIG. 13C. Here the sensor 32 has a cable that connects it to the electronics module 31, which is located remotely. For example, module 31 may be incorporated into a display and base station 36, which may be reused with different capnometer units 30. Base station 36 may then incorporate more complex hardware and software for capnography, for example, display or analysis systems. Signal and power cord 35 to the sensor may be removably connected to unit 30, allowing only the sensor unit 30 to be discarded and replaced.

It also is desirable to provide disposable capnometer sensing adaptors, wherein the sensing package is installed directly in the main air channel of the respiratory stream. FIGS. 13D and 13E show exemplary embodiments of this type. FIG. 13D shows a capnometer sensing and airflow adaptor unit 40, comprising a tubular adaptor 44 with internal air channel 49. Nanoelectric unit 42 may be mounted to the wall of channel 49, and connected to a cable connector 47 mounted on the outside of adaptor 44 by a wire. It is possible, for example, to integrate sensing unit 42 and its connecting wires into the adaptor 44 during a plastic molding process, thereby minimizing the possibility for leakage into or out of channel 49 adjacent to the sensor 42. Sensor 42 may comprise a nanotube device as described above. It may be protected from contamination by a suitable filter and/or gas-permeable membrane (not shown) disposed around or over the sensor. For example, one may encapsulate sensor 12 in a gas-permeable membrane material, and/or a suitable filter or membrane may be mounted in channel 49.

Alternatively, one may dispose the sensing unit more directly in the airstream. For example, FIG. 13E shows a capnometer sensor and adaptor 50, wherein a nanoelectric sensor 52 is mounted in the center of channel 59 using a plurality of ribs 58. Ribs 58 may be molded integrally with sensor 52 and/or adaptor housing 54, with a molded-in connection to cable 55. In the alternative, ribs 58 and sensor 52 may comprise a sub-assembly that is later assembled in housing 54. Such a sub-assembly may attach to a molded-in electrical connector (not shown) passing through the wall of housing 54. It should be apparent that either design would virtually eliminate the possibility for inaccurate sensor readings from outside air leakage. Ribs 58 or any other suitable mounting structures for sensor 52 may also be used to hold protective filters and membranes around sensor 52. Such a design may be particularly suitable for monitoring respiration from a subject in blow-testing equipment such as used for blood-alcohol testing and the like.

FIG. 13F is a schematic diagram showing a side view of a capnometer sensor and adapter 30 generally similar to that shown in FIGS. 13A1 and 13A2, but having a sensor 62 arranged adjacent a secondary parallel lumen 66 in communication with the airway passage 69. Window or opening 63 communicates to parallel lumen 66 directly, and is in only indirect communication with passage 69. FIG. 13G is a schematic diagram showing a side view of a capnometer sensor and adapter generally similar to that shown in FIG. 13F, but having inlet and outlet ends 66a and 76b of the secondary parallel lumen 76 projecting into airway passage 79 into the exhalation flow path. Note that the examples of FIGS. 13F-13G show the parallel lumen arranged close to the adaptor housing and primary passage. Alternatively, the parallel lumen may be extended, so that senor, electronic circuitry, displays, and/or data memory are located remotely from the airway.

Having thus described preferred embodiments of the methods and devices having aspects of the invention, it should be apparent to those skilled in the art that certain advantages of the within system have been achieved. It should also be appreciated that various modifications, adaptations, and alternative embodiments thereof may be made within the scope and spirit of the present invention. For example, the methods and devices described may be employed for the sensing of biopolymers such as nucleic acids, proteins and the like; for the detection of organisms or fragments of organisms; and/or for forensics such as genetic identification, and the like.

1. A breath analyzer, comprising:
at least a first nanoelectronic sensor, the sensor including
a substrate;
one or more nanostructures disposed over the substrate;
one or more conducting elements in electrical communication with the nanostructure; and
at least one recognition material operatively associated with the first nanostructure, the at least one recognition material configured to provide a sensitivity to a first analyte found in human breath;
a breath sampler configured to sample at least the exhaled breath of a patient, and in communication with the sensor;
a processing unit configured to receive a signal from the first sensor and to use the signal to measure the concentration of the first analyte, so as to provide information related to a medical state of the patient.

2. The breath analyzer of claim 1, further comprising a output device to provide information related to the a medical state of the patient to a user.

3. The breath analyzer of claim 1, further comprising:
at least a second nanoelectronic sensor, the sensor including
a substrate;
one or more nanostructures disposed over the substrate;
one or more conducting elements in electrical communication with the nanostructure; and
at least one recognition material operatively associated with the first nanostructure, the at least one recognition material configured to provide a sensitivity to a second analyte found in human breath; and
wherein the processing unit is configured to receive a signal from the second sensor to use the signal to measure the concentration of the second analyte, so as to provide information related to a medical state of the patient.

4. The breath analyzer of claim 3, wherein the processing unit is configured to compare the measurement of the first analyte with the measurement of the second analyte, so as to determine a relationship between the measurements indicative of a medical state of the patient.

5. The breath analyzer of claim 4, wherein the first analyte includes carbon dioxide (CO₂) and the second analyte includes nitric oxide (NO).

6. The breath analyzer of claim 5, wherein the processing unit is configured to determine a relationship of the measured concentrations of CO₂ and NO in the sampled breath so as to provide an assessment of human airway inflammation of the patient.

7. The breath analyzer of claim 6, wherein the assessment of human airway inflammation of the patient is indicative of an asthma status, and the output device to provide information related to the an asthma status to a user.

8. The breath analyzer of claim 7, wherein the breath analyzer is substantially portable by a patient, and is configured to provide information related to the an asthma status to the patient on a substantially real-time basis.

9. The breath analyzer of claim 1, wherein the one or more nanostructures disposed over the substrate comprises a network of carbon nanotubes.

10. The breath analyzer of claim 9, wherein at least a portion of the network is in contact with the one or more conducting elements.

11. The breath analyzer of claim 10, wherein the one or more conducting elements include a source and a drain electrode separated from one another by a source-drain gap.

12. The breath analyzer of claim 11, wherein the network of carbon nanotubes comprises nanotubes having a characteristic length, and wherein the characteristic length is substantially less than the source-drain gap, so that the nanotubes comprising the network substantially contact at most only one of the source and drain electrodes.

13. The breath analyzer of claim 11, wherein the network of carbon nanotubes comprises nanotubes having a characteristic length, and wherein the characteristic length is substantially greater than the source-drain gap, so that a substantial portion of the nanotubes comprising the network contact both the source and the drain electrodes.

14. The breath analyzer of claim 1, further comprising a gate electrode; and wherein the sensor signal is indicative of a property of the nanostructure under the influence of a gate voltage.

15. The breath analyzer of claim 1, wherein the sensor signal is indicative of a capacitance property of the nanostructure.

16. The breath analyzer of claim 4, wherein the first analyte and second analyte are selected from the group consisting essentially of CO₂, NO, NO₂, and H₂O₂.

17. The breath analyzer of claim 5, wherein the breath sampler is configured to delivery a continuing breath sample to either or both of the first sensor and the second sensor during at least a substantial portion of a patient exhalation; and wherein the processing unit is configured to determine a history of the concentration of either or both of the first analyte and the second analyte during the exhalation.

18. The breath analyzer of claim 1, wherein the breath sampler is configured to control pressure of the breath sample during the course of a patient exhalation.
